(19) United States
(12) Patent Application Publication
(10) Pub. No.: US 2025/0369188 A1
(43) Pub. Date: Dec. 4, 2025

(54) POLYMERIC MATERIALS AND METHODS OF PRODUCING SAME

(71) Applicant: THE UNIVERSITY OF BRITISH COLUMBIA, Vancouver (CA)

(72) Inventors: Feng JIANG, Vancouver (CA); Penghui ZHU, Vancouver (CA); Jungang JIANG, Vancouver (CA); Sibo TIAN, Vancouver (CA)

(21) Appl. No.: 18/874,726

(22) PCT Filed: Jun. 12, 2023
(86) PCT No.: PCT/CA2023/050807

§ 371 Date: Dec. 13, 2024

Related U.S. Application Data
(60) Provisional application No. 63/352,736, filed on Jun. 16, 2022.

(51) Int. Cl. D21H 11/18; C08J 5/18; D21B 1/14; D21C 3/02

(52) U.S. Cl. CPC D21H 11/18; C08J 5/18; D21B 1/14; D21C 3/02; C08J 2301/02

(57) ABSTRACT

A method for producing a polymeric material is disclosed. The method combines blending of fibers and treating the fibers with a basic aqueous solution. In some embodiments, the blending of the fibers is performed at a blending speed sufficient to shear the fibers in one or both of a longitudinal direction and lateral direction of the fibers. In some embodiments, one or both of the blending and treating are performed in a sub-zero temperature, at a temperature of less than 0° C., or in a range of from about 0° C. to about −20° C. One example application of the method is in the making of a cellulose film from wood pulp.

### CROSS-REFERENCE TO RELATED APPLICATIONS

This application claims priority from U.S. application No. 63/352,736 filed Jun. 16, 2022 and entitled TRANSPARENT AND BIODEGRADABLE CELLULOSE FILM which is hereby incorporated herein by reference for all purposes. For purposes of the United States of America, this application claims the benefit under 35 U.S.C. § 119 of US application No. U.S. application No. 63/352,736 filed 16 Jun. 2022 and entitled TRANSPARENT AND BIODEGRADABLE CELLULOSE FILM which is hereby incorporated herein by reference for all purposes.

### FIELD OF THE INVENTION

This invention relates generally to polymeric materials, and methods of making polymeric materials. Specific embodiments provide methods for making cellulose films.

### BACKGROUND

Plastic films have been widely used as packaging materials. Due to is single-use and non-biodegradable properties, plastic films have created serious environmental concerns. There has been a desire to replace synthetic plastics with cellulose films. Methods of making cellulose films are known in the art. Several methods have been developed to make transparent cellulose films. The films are prepared from either dissolved cellulose or cellulose nanofibrils. In one method, cellulose is dissolved in various solvents including NaOH/urea, ionic liquid, N-methylmorpholine N-oxide (NMMO), benzyltrimethyl ammonium hydroxide (BzMe3NOH), and then regenerated into transparent films. In another method, attempts have been made to fabricate cellulose nanofibrils (CNFs) films from processes such as (2,2,6,6-Tetramethylpiperidin-1-yl)oxyl (TEMPO) oxidation, carboxymethylation, high-pressure homogenization, microfluidization, and supermasscolloider grinding. However, nanofibrillation or cellulose dissolution requires substantial amounts of chemicals and energy input, which significantly reduces the sustainability of the derived cellulose film.

The inventors have recognized a general need for improved polymeric materials, such as cellulose films, and methods of making same. There is a particular need for such methods to be simple, require low processing time, and/or require low energy and chemical inputs.

### SUMMARY

The invention has a number of aspects. One aspect of the invention relates to methods of making polymeric materials from fibrous materials by combining blending of the fibers and mixing of the fibers with a basic aqueous solution.

In some embodiments, one or both of the blending and mixing steps are performed in sub-zero temperatures, at a temperature of less than 0° C., or in a range of from about 0° C. to about −20° C. In some embodiments, only the mixing step is performed in sub-zero temperatures. In some example embodiments, the basic aqueous solution is cooled to sub-zero temperatures before mixing into the fibers.

In some embodiments, the blending of the fibrous material comprises shearing the fibers along a longitudinal direction of the fibers to obtain a blended fibrous material. The blended fibrous material comprises blended fibers having an average diameter that is less than an average diameter of the fibers. In some embodiments, the average diameter of the blended fibers is at least about 60% or at least 80% smaller than the average diameter of the fibers.

In some embodiments, the blending of the fibrous material is at a blending speed that is greater than about 5,000 rpm, and in some embodiments, in the range of from about 5,000 to about 30,000 rpm.

In some example embodiments, the method comprises the steps of (a) blending a fibrous material to obtain a blended fibrous material; (b) mixing the fibrous material in a basic aqueous solution before step (a), or mixing the blended fibrous material in the basic aqueous solution after step (a); (c) separating fibers contained in a mixture comprising the blended fibrous material and the basic aqueous solution; and (d) drying the separated fibers.

In some embodiments, the mixing step (b) is performed before the blending step (a). In some embodiments, the mixing step (b) and the blending step (a) are repeated for a predetermined number of cycles, for example, between 1 and 10 cycles.

In some embodiments, the method further comprises fibrillating the fibers contained in the fibrous material before the blending step (a) and/or the mixing step (b). The fibrillating of the fibers may comprise passing the fibers through a grinder. In some embodiments, the grinder is operated at a grinding speed in the range of from about 500 rpm to about 2,000 rpm.

In some embodiments, the mixture comprising the blended fibrous material and the basic aqueous solution is diluted in a solvent to a concentration before the separating step (c). The solvent may be water. In some embodiments, the concentration of the blended fibrous material in the mixture is in the range of from about 0.05 wt. % to about 5 wt. %.

In some embodiments, the method further comprises pressing the separated fibers to form a film. In some example embodiments, the film has a thickness in the range of from about 10 μm to about 200 μm. The drying and the pressing steps may be performed separately or simultaneously.

In some embodiments, the blending of the fibrous material in step (a) comprises shearing the fibers along a lateral direction of the fibers. In such embodiments, a mean length of the blended fibers is less than a mean length of the fibers. In some example embodiments, the mean length of the blended fibers is at least about 50% less than the mean length of the fibers.

In some embodiments, the basic aqueous solution comprises a pH in the range of from about 10 to about 14. In some example embodiments, the basic aqueous solution comprises a metal hydroxide. In some non-limiting examples, the metal hydroxide comprises one or more of sodium hydroxide (NaOH), potassium hydroxide (KOH), and lithium hydroxide (LiOH).

One aspect of the invention relates to polymeric materials prepared by the methods of this invention. The polymeric materials prepared by the methods of this invention may be in the form of a film, with a thickness in the range of from about 10 μm to about 200 μm. In some embodiments, the cellulose contained in the polymeric materials comprises a cellulose II.

In some embodiments, the polymeric materials comprise one or more of the following characteristics when the film has a thickness between about 35 μm and about 50 μm:
transmittance to visible light at a wavelength of 550 nm in the range of about 70% to about 95%;
haze value at a wavelength of 550 nm in the range of from about 50% to about 90%;
tensile strength of the polymeric material in the range of from about 30 MPa to about 120 MPa;
tensile strain of the polymeric material in the range of from about 5% to about 30%;
work of fracture of the polymeric material in the range of from about 1 MJ/m³ to about 30 MJ/m³;
oxygen barrier property of less than about 3.0 cm³·μm·m⁻²·day¹·kPa⁻¹; and/or
substantially degraded within a period of about 10 days to about 30 days of incubation in soil at ambient conditions.

One example application of the method of the invention relates to making cellulose films. The cellulose films may be prepared from wood pulp. The cellulose films comprise a plurality of cellulose fibers. In some embodiments, the cellulose fibers comprise a mean length of less than about 1 mm. In some embodiments, the cellulose fibers comprises the cellulose II structure. In some embodiments, the cellulose fibers comprises a mean length in the range of from about 200 μm to about 800 μm. In some embodiments, the cellulose fibers comprises an average diameter in the range of from about 20 μm to about 100 μm.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flow chart illustrating the steps of making a polymeric material according to an example embodiment.

FIGS. 2a 2b, 2c, and 2d are optical images of cellulose suspensions that have been treated under different treatment conditions observed at 12 h, 2 d, 4 d, and 8 d after treatment respectively. The treatment cycles are labelled in a1, and follow the same sequence for all images.

FIG. 2e are plots of precipitation height over time for cellulose suspensions treated under different conditions for 4 cycles.

FIG. 2f are plots of precipitation height over time for cellulose suspensions treated using 10% NaOH concentration and −10° C. for 1-4 cycles.

FIGS. 2g, 2h, 2i and 2j are plots of precipitation height (%) over time (h) for cellulose suspensions treated under different conditions of NaOH concentration, temperature, and blending times.

FIGS. 3a, 3b, 3c, 3d and 3e are polarized optical microscopy images of (a) original cellulose fibers and fibers going through (b) 1, (c) 2, (d) 3, and (e) 4 treatment cycles at 10% NaOH concentration and −10° C.

FIG. 3f is a plot of the length weighted mean length (mm) of the original cellulose fibers and each of the treated cellulose fibers of FIGS. 3a to 3e corresponding to the respective optical microscopy images.

FIG. 3g is a plot of mean width (μm) of the original and treated cellulose fibers of FIGS. 3a to 3e corresponding to the respective optical microscopy images.

FIG. 4a are laser scattering images of the (a₁) control sample and the sample blended for (a₂) 1, (a₃) 2, (a₄) 3, (a₅) 4 times at 10% NaOH concentration and −10° C. conditions.

FIG. 4b show visual appearances of the cellulose film (10%, −10° C., 4) (b₁) in close contact with and (b₂) 3, (b₃) 12, and (b₄) 21 mm away from colour printed text.

FIG. 4 is a plot of the light transmittance (%) over wavelength (nm) of the control cellulose film and the film treated with different conditions using a UV-Vis spectrophotometer without (c) and with (d) an integrated sphere.

FIG. 4e is a photograph of an origami paper crane folded using the cellulose film prepared by the FIG. 1 method.

FIG. 4f is a photograph showing the setup of the laser scattering test used in the Examples to demonstrate the haze of the product films.

FIG. 4g is a photograph showing the appearance of a piece of a large cellulose film being treated with 10% NaOH concentration, at −10° C. and 4 treatment cycles, i.e., ““10%, −10° C., 4” fibers.

FIG. 5 are SEM images of the films made from (a₁ and b₁) untreated kraft pulp (a₂ and b₂) “10%, −10° C., 1” fibers, and (a₃ and b₃) “10%, −10° C., 4” fibers.

FIG. 5b is a schematic diagram showing a contact angle of the film that is made from “10%, −10° C., 4” cellulose fibers.

FIGS. 5c1 and 5c2 are cross-sectional SEM images of the films made from (c₁) untreated kraft pulp and (c₂) “10%, −10° C., 4” fibers.

FIG. 6a are Fourier-transform infrared spectra (plot of transmittance (a.u.) over wavelength (cm⁻¹) of the films from original and treated pulp fibers.

FIG. 6b are X-ray diffraction (XRD) patterns (plot of intensity (a.u.) over 2 Theta (°)) of the films from original and treated pulp fibers.

FIG. 6c are TGA curves (plot of weight (%) over temperature (° C.)) of the films from original and treated pulp fibers.

FIG. 6d are DTGA curves (plot of deriv. weight change (%/° C.) over temperature (° C.)) of the films from original and treated pulp fibers.

FIG. 6e is a plot of proportion (%) of cellulose and hemicellulose content of NBSK pulp and treated pulp by composition analysis.

FIG. 6f are photographs illustrating the appearance of TEMPO-oxidized cellulose nanofibril (TOCNF) film (left) and 10%, −10° C., 4 film (right) in a dry 105° C. oven over time (0 h, 44 h, 118 h, and 480 h).

FIG. 7a are stress-strain curves (plot of stress (MPa) over strain (%)) of original and treated (10%, −10° C., at various treatment cycles) pulp fibers.

FIG. 7b is a plot of stress (MPa) in dark colour and Young's modulus (GPa) in light colour, of the original and treated (10%, −10° C., at various treatment cycles) pulp fibers.

FIG. 7c is a plot comparing the tensile strength (MPa) with various polymers.

FIG. 7d is a plot comparing toughness (MJ/cm³) of the films made from original and treated (10%, −10° C.) pulp fibers as calculated from the FIG. 7a tensile stress-strain curves.

FIG. 8a is a photograph showing the “10%, −10° C., 4” film soaked in DI water.

FIG. 8b is a plot of stress (MPa) over strain (%) of the “10%, −10° C., 4” film after soaking in water for 1 day, 10 days, and 30 days.

FIGS. 8c, 8d and 8e are photographs showing the results of the biodegradability tests of the “10%, −10° C., 4” film and LDPE film after burying the films under soil.

FIG. 9a is a photograph of a bottle containing 1 L of the CS-1.0 sample prepared in Example 2.

FIG. 9b is a plot of filtration time (minutes) for each of the CF-0.1, CF-0.3, CF-0.5, CF-0.8, and CF-1.0 samples prepared in Example 2.

FIG. 9c is a photograph of each of the CF-0.1, CF-0.3, CF-0.5, CF-0.8, and CF-1.0 samples prepared in Example 2.

FIG. 10a, 10b, 10c, 10d and 10e are optical microscope images of (a) the CS-1.0, (b) CS-0.8, (c) CS-0.5, (d) CS-0.3, and (e) CS-0.1 samples prepared in Example 2.

FIG. 10f and FIG. 10g are photographs of bottles of cellulose fiber suspensions containing the CS-1.0, CS-0.8, CS-0.5, CS-0.3, and CS-0.1 samples (f) before and (g) after 14 days.

FIG. 10h is a plot of precipitation height (%) of cellulose fiber suspensions containing the CS-1.0, CS-0.8, CS-0.5, CS-0.3, and CS-0.1 samples after 14 days.

FIGS. 11a and 11b are photographs showing the cellulose film samples CF-1.0, CF-0.8, CF-0.5, CF-0.3, are CF-0.1 prepared in Example 2 (a) in close contact with and (b) 3 mm away from the color-printed substrate.

FIG. 11c is a plot of light transmittance (%) over the wavelength from 400 to 800 nm for each of the cellulose film samples CF-0.1, CF-0.3, CF-0.5, CF-0.8, and CF-1.0 prepared in Example 2.

FIG. 11d is a plot of haze (%) over the wavelength from 400 to 800 nm for each of the cellulose film samples CF-0.1, CF-0.3, CF-0.5, CF-0.8, and CF-1.0 prepared in Example 2.

FIG. 12a, 12b, 12c, 11d, and 12e are SEM images showing the top-view morphology of the (a) CF-1.0, (b) CF-0.8, (c) CF-0.5, (d) CF-0.3, and (e) CF-0.1 samples prepared in Example 2.

FIG. 12f, 12g, 12h, 12i, and 12j are SEM images showing the cross-sectional morphology of the (f) CF-1.0, (g) CF-0.8, (h) CF-0.5, (i) CF-0.3, and (j) CF-0.1 samples prepared in Example 2.

FIG. 13a is a plot of stress (MPa) over strain (%) of the CF-1.0, CF-0.8, CF-0.5, CF-0.3, and CF-0.1 cellulose film samples prepared in Example 2.

FIG. 13b is a plot of work of fracture (MJ/m³) calculated for the CF-1.0, CF-0.8, CF-0.5, CF-0.3, and CF-0.1 cellulose film samples prepared in Example 2.

FIG. 13c is a plot of stress (MPa) over strain (%) of the CF-1.0, CF-0.8, CF-0.5, CF-0.3, and CF-0.1 wet cellulose film samples prepared in Example 2.

FIG. 13d is a plot of water absorption (%) over time (min) of the CF-1.0, CF-0.8, CF-0.5, CF-0.3, and CF-0.1 cellulose film samples prepared in Example 2.

FIG. 14a is a photograph showing the cellulose films prepared in Example 2 in a folded form to support their flexibility.

FIG. 14b is a photograph showing the cellulose films prepared in Example 2 comprising printed text on the surfaces thereof to support their printability.

FIG. 14c are TGA curves (a plot of weight (%) over temperature (° C.)) showing the thermal stability of the CF-1.0, CF-0.8, CF-0.5, CF-0.3, and CF-0.1 cellulose film samples prepared in Example 2.

FIG. 14d is a plot comparing the oxygen barrier property of the cellulose film prepared in Example 2 and other commonly-used petroleum-based and bio-based polymers for packaging applications.

FIG. 14e are photographs comparing the biodegradability of the cellulose film prepared in Example 2 and a polyethylene film control.

FIGS. 15a, 15b, 15c, and 15d are optical microscope images of (a) original fibers, (b) MFC, (c) high-speed blended MFC, and (d) NaOH swelling MFC prepared in Example 3.

FIG. 15e is a plot of relative frequency (%) over fiber diameter (μm) of MFC.

FIG. 15f is a plot of relative frequency (%) over fiber diameter (μm) of high-speed blended MFC.

FIG. 15g is a plot of relative frequency (%) over fiber diameter (μm) of NaOH swelling MFC.

FIG. 15h is a photograph of bottles containing NaOH swelling MFC suspension, 1 L per bottle.

FIG. 15i is a photograph of the prepared transparent MF-B10-C10.

FIGS. 16a, 16b, and 16c are visual appearances demonstrating the light transmittance of each of the (a) MF, (b) MF-B10, and (c) MF-B10-C10 cellulose film samples prepared in Example 3 which were placed in close contact with the color-printed substrate.

FIGS. 16d, 16e, and 16f are visual appearances demonstrating the haze property of each of the (d) MF, (e) MF-B10, and (f) MF-B10-C10 cellulose film samples prepared in Example 3 which were placed about 3 mm away from the color-printed substrate.

FIG. 16g is a plot of light transmittance (%) over wavelength from 400 to 800 nm for each of the MF, MF-B10, and MF-B10-C10 cellulose film samples prepared in Example 3.

FIG. 16h is a plot of haze (%) over wavelength from 400 to 800 nm for each of the MF, MF-B10, and MF-B10-C10 cellulose film samples prepared in Example 3.

FIGS. 17a, 17b, 17c, 17d, 17e and 17f are SEM images which show the top-view morphology of (a,d) MF, (b,e) MF-B10, and (c,f) MF-B10-C10.

FIG. 17g are FTIR spectra (plot of transmittance (a.u.) over wavelength (cm⁻¹) of MF, MF-B10, and MF-B10-C10.

FIG. 17h are XRD patterns (plot of intensity (a.u.) over 2 Theta (o) of MF, MF-B10, and MF-B10-C10.

FIG. 17i are TGA curves (plot of weight (%) over temperature (° C.) of MF, MF-B10, and MF-B10-C10.

FIG. 18a are stress strain curves (plot of stress (MPa) over strain (%)) of MF, MF-B10, and MF-B10-C10.

FIG. 18b is a plot comparing the stress (MPa) and Young's modulus of MF, MF-B10, and MF-B10-C10.

FIG. 18c is a plot comparing the work of fracture (MJ/m³) of MF, MF-B10, and MF-B10-C10.

FIG. 18d is a SEM image showing the flat cross-section of fractured MF-B10-C10.

FIG. 18e is a SEM image showing the fracture of the microfibers.

FIG. 18f is a SEM image showing the formed microcracks after stretching.

FIG. 18g is a photograph showing the stress whitening of the fractured MF-B10-C10.

FIG. 18h is a plot comparing the stress (MPa) and strain (%) of the cellulose film prepared in Example 3 and other commercial transparent films/papers.

FIG. 18i is a plot comparing the works of fracture (MJ/m3) of the cellulose film prepared in Example 3 and other commercial transparent films/papers.

FIGS. 19a and 19b are photographs demonstrating the mechanical strength of the strips (10×2.0 cm²) cut from (a) MF-B10-C10 prepared in Example 3 and (b) a commercial shopping bag.

FIGS. 19c and 19d are photographs demonstrating the wet strength of the strips (10×2.0 cm²) cut from (c) MF-B10-C10 prepared in Example 3 and (d) a commercial shopping bag.

FIG. 19e are photographs demonstrating the biodegradability of MF-B10-C10 prepared in Example 3 in the soil.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

### Example Methods of Making Polymeric Materials

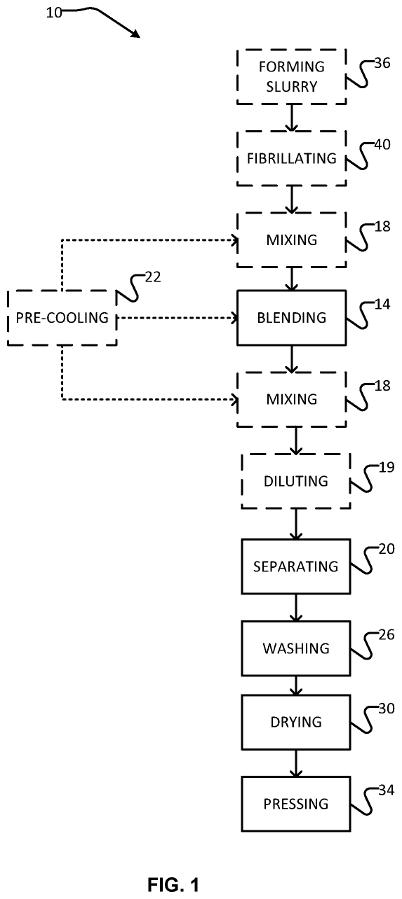

FIG. 1 is a flow chart illustrating the steps of an example method 10 of making polymeric materials. The method may involve using a fibrous material as a raw material. In some embodiments, the fibrous material comprises a source of cellulose. The fibrous material may for example comprise pulp. Any suitable pulp may be used in the method 10. This includes for example wood pulp such as softwood pulp and hardwood pulp. In one non-limiting example, the pulp comprises Northern Bleached Softwood Kraft (NBSK).

Referring to FIG. 1, in block 14, the fibrous material is blended to obtain a blended fibrous material. The blended fibrous material comprises blended fibers. The blending of the fibrous material may comprise shearing the fibers along one or both of a longitudinal and lateral direction of the fibers so as to reduce a diameter and/or a length of the fibers respectively.

The blending of the fibrous material may be performed using any suitable mechanical blending device including but not limited to a blender, grinder, pulverizer, cutter, shredder, etc. In some embodiments, the mechanical blending device comprises one or more shearing blades. In one example embodiment, the one or more shearing blades are rotatably mounted to an elongated shaft, which is operatively connected to a motor. The motor may drive the rotation of the shaft, which in turn rotates the one or more shearing blades. The term “shearing blade” as used here encompasses broadly any shearing means, including a cutter, knife, razor, etc., and in any suitable forms.

In some embodiments, the blending of the fibrous material is performed at a blending speed that is sufficient to exert a mechanical shear force on the fibers so as to reduce the diameter of at least some of the fibers contained in the fibrous material. In some embodiments, the average diameter of the blended fibers is smaller than the average diameter of the fibers. In some example embodiments, the average diameter of the blended fibers is at least about 60% smaller than the average diameter of the fibers, and in some embodiments, at least about 70%, and in some embodiments, at least about 80%, and in some embodiments, at least about 90%.

In some embodiments, the blending of the fibrous material is performed at a high blending speed greater than 500 revolutions per minute (RPM), and in some embodiments, greater than about 800 RPM, and in some embodiments, greater than about 1,000 RPM, and in some embodiments, greater than about 5,000 RPM, and in some embodiments, greater than about 10,000 RPM. In some embodiments, the blending of the fibrous material is performed at a blending speed in the range of from about 500 RPM to about 30,000 RPM. In some embodiments, the blending speed is the shearing speed, i.e., the speed at which the fibers contained in the fibrous material are being sheared.

In some embodiments, the blending of the fibrous materials shears the fibers along a lateral direction of the fibers. In some embodiments, a mean length of the blended fibers is at least about 50% less than a mean length of the fibers, and in some embodiments, at least about 55%, and in some embodiments, at least about 60%, and in some embodiments, at least about 70%, and in some embodiments, at least about 80%. In some embodiments, a mean length of the blended fibers is about 50% to about 90% less than a mean length of the fibers, and in some embodiments, about 60% to about 85%.

For example, in some embodiments, a mean length of the blended fibers is less than about 1000 μm, and in some embodiments, less than about 800 μm. In some example embodiments, a mean length of the blended fibers is in the range of from about 100 μm to about 1000 μm, and in some embodiments, from about 100 μm to about 800 μm, and in some embodiments, about 200 μm to about 600 μm.

In some example embodiments, the blending step 14 is performed for a time period of between about 2 minutes and about 30 minutes, and in some embodiments, between about 2 minutes and about 20 minutes, and in some embodiments, between about 2 minutes and about 10 minutes.

In some embodiments of the method, in block 18, the fibrous material is mixed with an aqueous basic solution before the blending step 14. In such embodiments, the blending step 14 is performed after the mixing step 18.

In some embodiments of the method, the blended fibrous material is mixed with an aqueous basic solution after the blending step 14. In such embodiments, the blending step 14 is performed before the mixing step 18.

In some embodiments, mixing of the aqueous basic solution comprises stirring the aqueous basic solution with the fibrous material and/or blended fibrous material for a time period in the range of from about 5 to about 30 minutes, and in some embodiments, in the range of from about 5 to about 20 minutes, and in some embodiments, in the range of from about 5 to about 10 minutes.

The aqueous basic solution may comprise a concentration in the range of from about 2 wt % to about 20 wt %, and in some embodiments, in the range of from about 5 wt % to about 15 wt %.

The aqueous basic solution may comprise one or more organic and/or inorganic base compounds (e.g., with a pH greater than about 7). The aqueous basic solution may comprise one or more strong bases and/or one or more weak bases. In some embodiments, the aqueous basic solution comprises an ionic compound such as a metal hydroxide (e.g., sodium hydroxide (NaOH), potassium hydroxide (KOH), lithium hydroxide (LiOH), etc.). The aqueous basic solution may comprise a mixture of compounds. In some embodiments, the pH of the aqueous basic solution is in the range of from about 9 to about 14, and in some embodiments, from about 10 to about 14, and in some embodiments, from about 11 to about 13.

In some embodiments, one or both of the blending step 14 and the aqueous basic solution mixing step 18 are performed at a temperature in the range of from about −25° C. to about 25° C., and in some embodiments, in the range of from about −10° C. to about 10° C.

In some embodiments, one or both of the blending step 14 and the aqueous basic solution mixing step 18 is performed at a sub-zero temperature of less than about 0° C., and in some embodiments, at a temperature in the range of from about 0° C. to about −20° C., and in some embodiments, at a temperature in the range of from about −5° C. to about −15° C. In some embodiments, the aqueous basic solution mixing step 18 is performed at a sub-zero temperature, and the blending step 14 is performed at a temperature above 0° C.

In some embodiments, one or more of the fibrous material, blended fibrous material and the aqueous basic solution are pre-cooled to the desired temperature (block 22). In some embodiments, the fibrous material and/or the blended fibrous material is cooled to the desired temperature before blending and/or mixing. In some embodiments, the aqueous basic solution is cooled to the desired temperature before mixing into the fibrous material and/or blended fibrous material. In some embodiments, the blending and/or the mixing is performed in an environment maintained at the desired temperature, e.g., at room temperature and/or at sub-zero temperatures (e.g., inside a fridge or freezer, etc.).

In some embodiments, the blending step 14 and the mixing step 18 are repeated for a predetermined number of cycles. In some embodiments, the predetermined number of cycles is between 1 and 10, and in some embodiments, between 1 and 7, and in some embodiments, between 1 and 4. In some embodiments, repeating the mixing step 18 and the blending step 14 for one or more treatment cycles assists with obtaining a resulting blended fibrous material which comprises a desired fiber size and/or a desired number and/or size of fragments of fibers contained in the fibrous materials. In some embodiments, only one of the blending step 14 and mixing step 18 are repeated.

The inventors have discovered that the combination of the alkaline treatment, and the blending of the pulp fibers at blending speeds sufficient to cause mechanical shearing of the fibers produces blended fibers which have much smaller diameters and/or smaller fragments and/or shorter lengths as compared to the pre-treated pulp fibers. Such blended fibers advantageously produces polymeric materials (e.g., polymeric films) with desirable physical characteristics. In some embodiments, the alkaline treatment is performed under sub-zero temperatures.

In step 20, fibers in the base-treated blended fibrous material (i.e., mixture comprising the blended fibrous material and the aqueous basic solution) may be separated from the liquids contained in the mixture. The separating step 20 may separate the desired fibers (e.g., by size, etc.) from other solids or contaminants contained in the mixture. Any suitable separation methods for obtaining the desired fiber(s) from the mixture may be used, including for example, filtration, centrifugation, screening, decantation, or other physical and chemical separation methods.

In one example embodiment, the separation is performed by filtration. In some embodiments, the separation is performed under a vacuum, or a negative pressure. The separation may for example be performed by vacuum filtration. In embodiments in which the separation is performed by filtration, the pore size of the membrane filter is less than about 3.0 μm, and in some embodiments, less than about 1.5 μm and, in some embodiments, less than about 0.8 μm, and in some embodiments, less than about 0.5 μm, and in some embodiments, in the range of from 0.2 μm to 1.5 μm.

The separating of the fibers in step 20 is performed for a time period in the range of from about 30 seconds to about 10 hours. In some embodiments, the time period for the separating step 20 is optimized by adjusting the concentration of the mixture comprising the blended fibrous material and the aqueous basic solution (step 19). In some embodiments, the concentration of the mixture is in the range of from about 0.05 wt. % to about 5 wt. % of the blended fibrous material, and in some embodiments, in the range of from about 0.05 wt. % to about 2 wt. % of the blended fibrous material, and in some embodiments, in the range of from about 0.05 wt. % to about 1 wt. % of the blended fibrous material. In some embodiments, the separating of the fibers in step 20 is performed for a time period of not more than about 30 minutes, and in some embodiments, not more than about 20 minutes, and in some embodiments, not more than about 10 minutes, and in some embodiments, in the range of from about 30 seconds to about 10 minutes.

In step 26, residual basic aqueous solution may be removed from the separated fibers. Residual basic aqueous solution may be removed by washing the separated fibers. In some embodiments, the removing comprises soaking the separated fibers in a solvent. In some embodiments, the solvent comprises water.

In some embodiments, the used basic aqueous solution is collected. The collected used basic aqueous solution may be recycled and supplied for use in mixing steps 18.

The separated fibers may be dried in step 30 to decrease a moisture content in the fibers. Any suitable drying methods may be used including but not limited to heat drying, freeze drying, vacuum drying, air-drying, drying by solvent, spray drying, supercritical extraction, etc.

In some embodiments, in step 34, the separated fibers are pressed to form a film. The pressing of the film in step 34 may be performed by any suitable pressing methods, such as by pressing the fibers between a set of rotatable rollers, and/or between a set of plates. In some example embodiments, the pressing of the separated fibers in step 34 comprises pressing the separated fibers to form a film with a thickness in the range of from about 10 μm to about 200 μm, and in some embodiments, in the range of from about 20 μm to about 100 μm, and in the range of from about 20 μm to about 80 μm.

In some embodiments, the pressing step 34 is performed before the drying step 30. In some embodiments, the pressing step 34 is performed after the drying step 30. In some embodiments, the separated fibers are dried and pressed simultaneously. The separated fibers may for example be heat pressed. In some examples, the separated fibers are pressed between a set of rotating heated rollers, or between a set of heated plates. In some example embodiments, the separated fibers are pressed at a temperature in the range of from about 50° C. to about 105° C., and in some embodiments, about 60° C. to about 90° C., and in some embodiments, about 70° C. to about 85° C. In some example embodiments, the separated fibers are pressed for a time period between about 30 minutes and about 10 hours, and in some embodiments, between about 1 hour and about 8 hours, and in some embodiments, between about 2 hours to about 6 hours.

The thickness and/or size (e.g., diameter) of the film may be optimized by adjusting one or more of operating conditions of the drying and/or pressing steps 30, 34. The operating conditions may include for example the pressing pressure, pressing time and/or temperature.

In some embodiments, the fibrous material is mixed in a solvent to form a slurry in step 36 before the blending step 14. The fibrous material may be mixed in the solvent to obtain a desired concentration. The solvent may for example be water. In some embodiments, the concentration of the fibrous material is in the range of from about 0.25 wt. % to about 30 wt. %, and in some embodiments, in the range of from about 0.25 wt. % to about 20 wt. %, and in some embodiments, in the range of from about 0.25 wt. % to about 10 wt. %, and in some embodiments, in the range of from about 0.5 wt. % to about 5 wt. %, and in some embodiments, in the range of from about 0.5 wt. % to about 2.5 wt. %.

In some embodiments, the fibers in the slurry are fibrillated in step 40 before the blending step 14. The fibrillating of the fibers in the slurry may facilitate the peeling off of fibrils or nanofibrils from a surface of the fibers. In some embodiments, the fibrillating of the fibers comprises grinding the fibers. In some example embodiments, the grinding may comprise passing the slurry through a grinder at a low grinding speed. In some embodiments, the low grinding speed is less than about 3,000 RPM, and in some embodiments, less than about 2,000 RPM. In some embodiments, grinding of the fibers contained in the slurry in step (g) comprises passing the slurry through a pair of rotatable grinding wheels.

Method 10 may be tuned to optimize one or more of the physical characteristics of the polymeric product (e.g., size, light transmittance, haze, mechanical strength, flexibility, printability, thermostability, barrier property, and biodegradability) and production efficiency by adjusting one or more of:
blending speed;
type of blender and the amount of pressure and/or power and/or force capable of exerting by the blender used;
the shearing blades in the blender (e.g., properties of the material of the blade, number of blades, the curvature of the blade, edge angle, etc.)
number of treatment cycles of the blending and/or mixing steps;
concentration and/or composition and/or pH of the aqueous basic solution;
concentration(s) and/or viscosity of the input material at each step (e.g., the fibrous material, blended fibrous material, basic solution treated fibrous material, etc.);
type of fibrous material;
operating conditions at each step such as time periods, temperature and pressure;
etc.

### Example Polymeric Materials Prepared by Example Methods

One example application of the methods 10 of the present invention is in the making of cellulose films. The cellulose films may be prepared using wood pulp fibers as the raw materials. In some example embodiments, the wood pulp fibers comprise Northern bleached softwood kraft (NBSK) pulp.

In some embodiments, the cellulose films of the present invention comprise a plurality of cellulose fibers. In some embodiments, the plurality of fibers have a mean length of less than 1 mm, and in some embodiments, less than about 800 μm, and in some embodiments, in the range of from about 200 μm to about 800 μm. In some embodiments, the average diameter of the fibers in the cellulose film is greater than about 20 μm, and in some embodiments, in the range of from about 20 μm to about 100 μm.

In some embodiments, the cellulose films comprise the crystal form of cellulose II. In some embodiments, the cellulose that make up the cellulose films is substantially in the form of cellulose II. In some embodiments, the cellulose films comprise less than about 10% wt. of cellulose I, or less than about 5 wt. % cellulose I.

The cellulose films of the present invention comprise physical characteristics that are desirable for use as a replacement or alternative to plastics. The cellulose films of the present invention has one or more of the following physical characteristics:
high transmittance to visible light (i.e., has a light transmittance to visible light at a wavelength of 550 nm greater than about 70%); and/or
good thermal stability (i.e., T_{degradation} of greater than about 200° C.); and/or
high mechanical strength (i.e., tensile strength of greater than about 70 MPa, tensile strain of greater than about 15%, and/or Young's modulus of greater than about 2 GPa); and/or
high stretchability (i.e., work of fracture of greater than about 1.0 MJ/m³);
good structural stability underwater (i.e., tensile strength of greater than 20 MPa after being immersed in water for 2 days); and/or
low oxygen barrier properties (i.e., less than about 3.0 cm³·μm·m⁻²·day¹·kPa⁻¹) and/or
excellent biodegradability (i.e., over 90% degradation of film in less than about 30 days of incubation in soil at ambient conditions); and/or
good printability; and/or
etc.

In some embodiments, the cellulose film has a transmittance to visible light at a wavelength of 550 nm in the range of about 70% to about 95%, and in some embodiments, in the range of from about 50% to about 80% when the film has a thickness between 35 μm and 50 μm.

In some embodiments, the cellulose film has a haze value at a wavelength of 550 nm in the range of about 50% to about 90%, and in some embodiments, in the range of from about 50% to about 80% when the film has a thickness between 35 μm and 50 μm.

In some embodiments, the degradation temperature of the cellulose film is in the range of from about 200° C. to about 450° C., and in some embodiments, in the range of from about 220° C. to about 400° C. when the film has a thickness between 35 μm and 50 μm.

In some embodiments, the tensile strength of the cellulose film is in the range of from about 30 MPa to about 120 MPa, in some embodiments, in the range of from about 70 MPa to about 95 MPa when the film has a thickness between 35 μm and 50 μm.

In some embodiments, the tensile strain of the cellulose film is in the range of from about 5% to about 30%, and in some embodiments, in the range 15% to about 30% when the film has a thickness between 35 μm and 50 μm. In some embodiments, the Young's modulus of the cellulose film is in the range of from about 2 GPa to about 6 GPa when the film has a thickness between 35 μm and 50 μm.

In some embodiments, the work of fracture of the cellulose film is in the range of from about 1 MJ/m³ to about 30 MJ/m³ when the film has a thickness between 35 μm and 50 μm. In some embodiments, the work of fracture of the cellulose film is greater than about 8 MJ/m³.

In some embodiments, the cellulose film has an oxygen barrier property less than about 3.0 cm³·μm·m·⁻²·day⁻¹·kPa⁻¹, and in some embodiments, in the range of from about 1.5 cm³·μm·m⁻²·day⁻¹·kPa⁻¹ to about 3.0 cm³·μm·m⁻²·day⁻¹·kPa⁻¹ when the film has a thickness between 35 μm and 50 μm.

In some embodiments, the cellulose film is substantially degraded (i.e., at least about 90% degraded) within a period of about 10 days to about 30 days of incubation in soil at ambient conditions, when the film has a thickness between 35 μm and 50 μm.

The invention is further described with reference to the following specific examples, which are not meant to limit the invention, but rather to further illustrate it.

### EXAMPLES

The method 10 illustrated in FIG. 1 was used to make the polymeric materials described in Examples 1, 2 and 3. In the example embodiments, the polymeric material is pressed to form a film. In the example embodiments, the polymeric materials were prepared using NBSK pulp. The polymeric material product comprises a cellulose film.

### Example 1

### Materials

Northern bleached softwood Kraft (NBSK) pulp was provided by Canfor Corporation, Canada. Sodium hydroxide (NaOH, pellet 97%) was purchased from Anachemia, Canada, and dissolved into deionized (DI) water for further use. All water used is DI water from a Barnstead Mega-Pure System.

Dispersion of Cellulose in NaOH Solution with Mechanical Treatment

In this example, NBSK pulp (2.5 g) was stirred in aqueous NaOH solution (250 mL, 8 and 10 wt %) for 10 minutes at −10° C. and −5° C. using an overhead stirrer at 750 rpm, and then blended in a blender (Vitamix™ VM0102B, United States) as a blending means at 27,000 rpm for 5 minutes. This completes one cold stirring-blending cycle, and the cycle was repeated for 4 times. The dispersed suspension was kept in refrigerator at 4° C. for future characterization. The control group was prepared by blending NBSK pulp using a Vitamix blender in purified water at 27,000 rpm for 5 minutes.

Samples from treatment groups are specifically named to be (X %, Y° C., Z) to represent the preparing conditions, where X % refers to the concentration of aqueous NaOH solution (8% or 10%), YC refers to the temperature of NaOH solution (−5 or −10° C.), and Z refers to the cold stirring/blending cycle numbers (from 1 to 4).

### Preparation of Transparent Film

After various treatments, 3 mL of the cellulose NaOH suspension was withdrawn and then diluted 3 times by aqueous NaOH of the same concentration. The suspension was then vacuum filtrated for 5 hours using a Nylon filter with 0.45 μm pore size. The film was then washed with deionized water for several days to completely remove the residual NaOH, and hot-pressed at 80° C. for 5 hours to dry of f the moisture. The film was designated as (X %, Y° C., Z) following the previously described naming convention. The yield of the films was calculated based on the following equation

$$Yield = \frac{{W}_{f}}{{W}_{s}} \times 100 \% \qquad ( 1 )$$

Where W_{f} and Wₛ represent the weight of the prepared film and the weight of the treated cellulose suspension used for filtration, respectively. The yields for “10, −10, 1”, “10, −10, 2”, “10, −10, 3”, and “10, −10, 4” films were calculated to be 70.7%, 69.3%, 68.9%, and 71.4%, respectively.

### Characterization

Polarized optical microscope. Morphology of the cellulose fibers going through various treatment cycles was performed using a polarized optical microscope (POM, Olympus Corporation, Tokyo, Japan). The samples used for observation were prepared by dripping the treated 1 wt % cellulose fibers suspension on glass slides.

Fiber dimensional analysis. The distribution and average of fiber length and width were analysed in duplicate by Fiber Quality Analyzer—360 (FQA, Op Test Equipment Inc, ON, Canada) following the specifications of ISO 16065-1. For sample preparation, 1 mL of treated pulp suspension was dialyzed (regenerated cellulose dialysis tubing: Nominal MWCO 12000-14000, Fisher Scientific) against water, and then diluted to 0.1 wt % concentration before running through the FQA.

Laser scattering test. Laser scattering tests on films of (10%, −10° C., 1), (10%, −1° C. 0, 2), (10%, −10° C., 3), (10%, −10° C., 4), and control group are executed using a laser pointer (green 532 nm, Slowlove™). The films were held 28.3 cm away from the target paper, and the laser pointer was placed against the film. All photos are taken with aperture F-1.7, focus 4 mm, shutter speed 1/500 s, and ISO-100.

UV-Visible Spectroscopy. The transmittance of the treated cellulose suspensions and films at wavelengths of 200 to 800 nm was measured by a Cary™ 60 UV-visible (UV-vis) spectrophotometer (Agilent Technologies, Santa Clara, CA, USA). The integrated multi-angle transmittance of films at wavelengths of 350 to 800 nm was measured by a Cary™ 7000 UV-vis spectrophotometer (Agilent Technologies, Santa Clara, CA, USA) with a 150 mm integrating sphere.

Scanning Electron Microscope. Microscopic morphology of the prepared films was characterized using a focused ion beam (FIB) scanning electron microscope (SEM, Helios NanoLab 650, FEI, USA) using 5.0 kV accelerating voltage.

Attenuated Total Reflectance-FTIR. Spectra Analysis Attenuated total reflectance Fourier transform infrared spectroscopy (ATR-FTIR, Bruker Optics Pty. Ltd., Billerica, MA, USA) was used to measure the chemical structure of the cellulose films over the range between 4000 cm⁻¹ and 600 cm⁻¹ with a diamond crystal. The spectra were collected from accumulation of 64 scans at a resolution of 4 cm⁻¹.

X-ray Diffraction Analysis. The X-ray diffraction patterns of all films were collected from 2θ ranging 5° to 65° by a Bruker™ D8-Advance X-ray d iffractometer (Bruker, Germany) equipped with Cobalt radiation of 40 kV and 50 mA at a scanning speed of 1% min. MDI Jade 6TM software (The Internationa I Centre for Diffraction Data) was used to shift 2θ obtained to match referential XRD data obtained with Cu target in the literature. The crystallinity index was calculated by the following empirical equation:

$$CrI = \frac{{I}_{t} - {I}_{a}}{{I}_{t}} \times 100 \% \qquad ( 2 )$$

where Iₜ represents the total intensity of the 200 peak for cellulose I and of the 020 peak for cellulose II, and Iₜₐ is the amorphous intensity for cellulose I and cellulose II.

Thermogravimetric Analysis. The thermal stability of the cellulose films was performed using a TGA-Q500TM thermogravimetric analyzer (TA Instruments, USA). Films were cut into small round pieces (around 5 mg to 10 mg) and then heated at 10° C./min from room temperature to 600° C. under nitrogen flow (50 m L/min).

Mechanical property analysis. The cellulose film was cut into strips with a width of about 2 mm and a length of around 25 mm. Tensile test is performed by Dynamic Mechanical Analyzer (DMA).

### Results

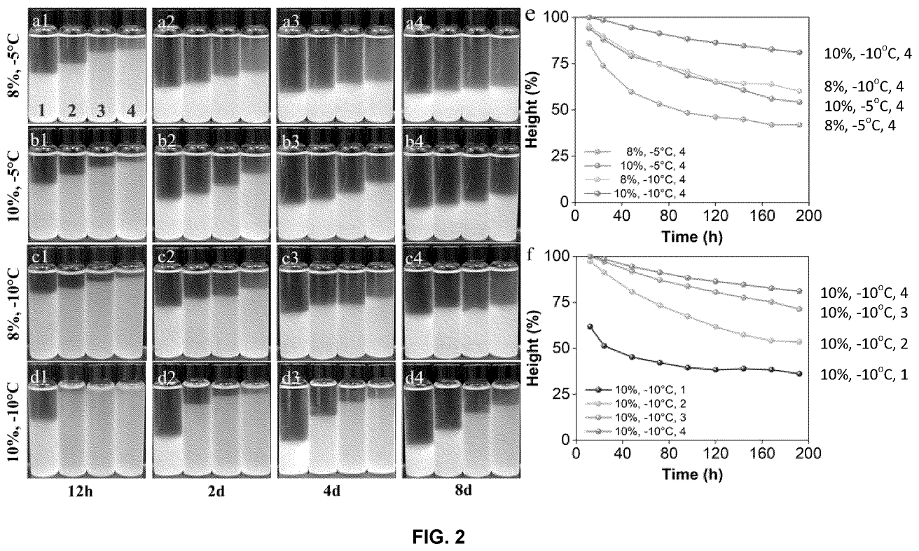

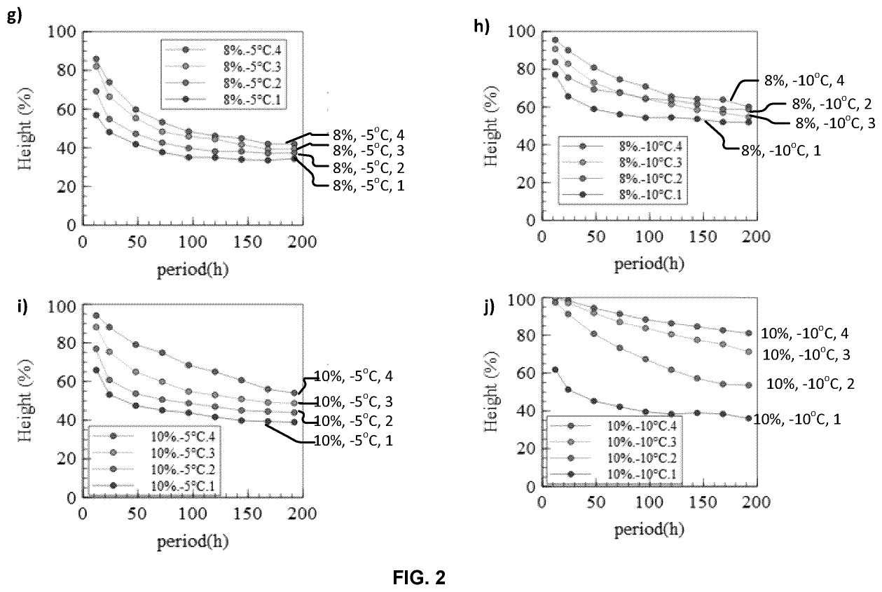

In one example, NBSK was subjected to four cycles of cold NaOH solution swelling (at 8% or 10% NaOH concentrations and −5 or −10° C. for 10 min) and high-speed blending (5 min at room temperature). The dispersibility and stability of the suspension subjected to the different treatment conditions and cycles were visualized from the precipitation tests in FIGS. 2a-d. The results show that more cellulose could be dispersed at enhanced treatment severity and cycles. The precipitation height is used to indicate the dispersibility of the suspension and presented in FIGS. 2e and 2f. Higher precipitation height can be observed with increasing NaOH concentration and decreased temperature (FIG. 2e). In addition, under the same treatment condition, by increasing the treatment cycles, higher precipitation height can also be observed regardless of the NaOH concentration and temperature (FIGS. 2f and 2g-j). The inventors believe that when cellulose is swollen in NaOH aqueous solution, more water molecules will diffuse into the cellulose fibers, which can reduce the density of the fiber as the density of cellulose (1.6 g/cm³) is higher than water. In addition, as the rate of sedimentation is proportional to the square of the hydrodynamic radius of the fibers, higher precipitation height may also suggest smaller fiber sizes. Therefore, the precipitation height may be used to correlate the swollen and disintegration state(s) of the cellulose fibers. The precipitation results suggest that more cellulose fibers can be swollen and disintegrated by treating with higher NaOH concentration, lower temperature, and more repetition of treatments within the testing ranges. Results also suggest that most stable cellulose-NaOH aqueous suspension can be obtained at 10% NaOH and −10° C. for 4 treatment cycl es, with the precipitation height maintaining as high as 81% even after 8 days.

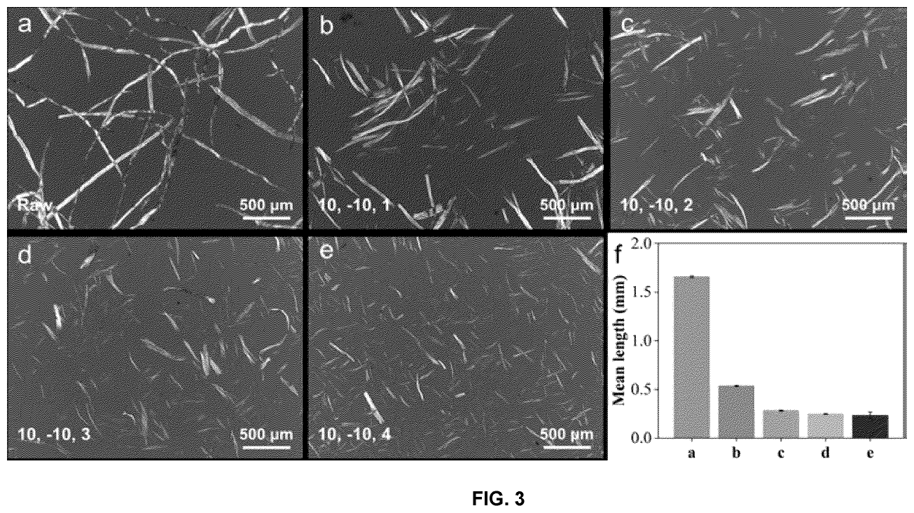

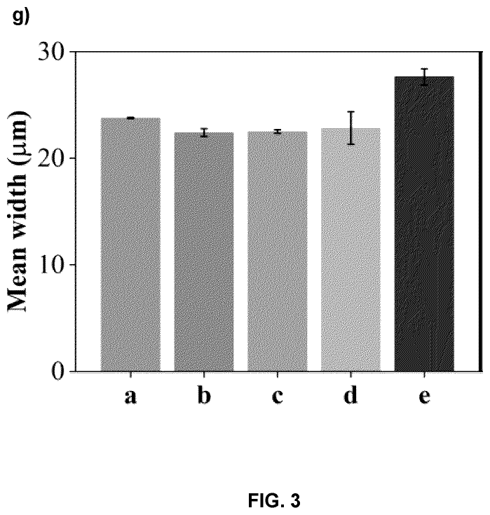

The treated pulp fibers were visualized using polarized optical microscope after each treatment cycle using 10% NaOH and −10° C. (FIG. 3a to 3e). Original pulp fibers appeared to be long and slender with fiber width of 18.5-36.6 μm (FIG. 3a). After one cycle of treatment, the pulp fibers showed apparent swelling, with some ballooning effects being observed along the fibers (FIG. 3b). This suggests that during the first cycle, pulp fibers went through heterogeneous swelling at the most accessible locations along the fiber, and such ballooning effects have been observed for cellulose fibers being treated with NaOH at sub-zero temperature and high-speed blending. The cold-alkaline treatment mechanism may be explained as follows. The inventors believe that at sub-zero temperatures, Na⁺ in the solution will interact with water molecules to form solvated dipole hydrates. The ions can penetrate into the amorphous and then crystalline regions of cellulose fiber to break the intermolecular hydrogen bonding, causing the heterogeneous swelling of the fibers, which can help the isolation of cellulose fibers with reduced size using a household blender. Further increasing the treatment cycle will lead to more severe fiber disintegration and significantly reduced fiber size. Under high-speed blending, the swollen fibers burst into smaller fibers due to weakened hydrogen bonds. Most fibers are teared into shorter pieces and fragments after four treatment cycles, because of the collective effect of both mechanical force and caustic swelling. The fiber length and width were determined using fiber quality analyzer (FQA) and presented in FIGS. 3f and 3g, respectively. For the fiber length, the original pulp fibers had a mean length of 1.66 mm, while after various treatment cycles, a monotonically decreasing can be observed with increasing cycles of treatment. Specifically, the mean length of the treated fibers decreased from about 540 μm to 240 μm with the increase of the treatment cycle from 1 to 4.

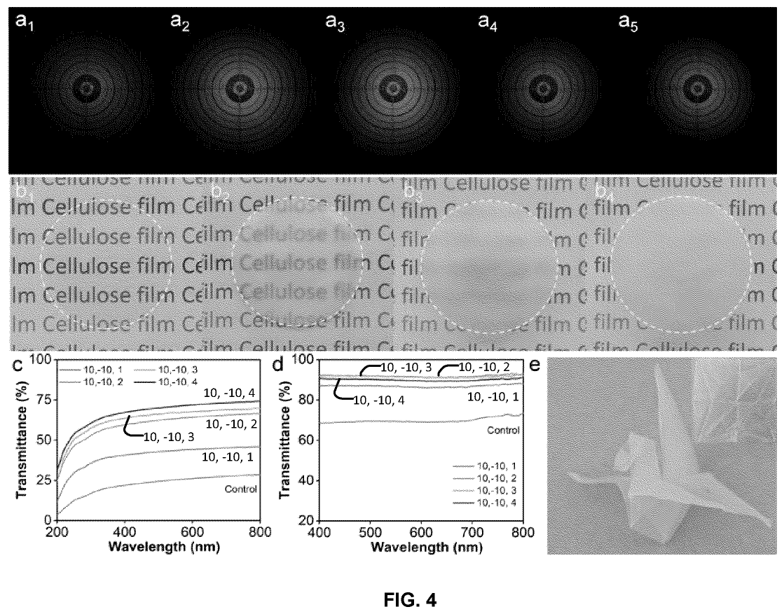

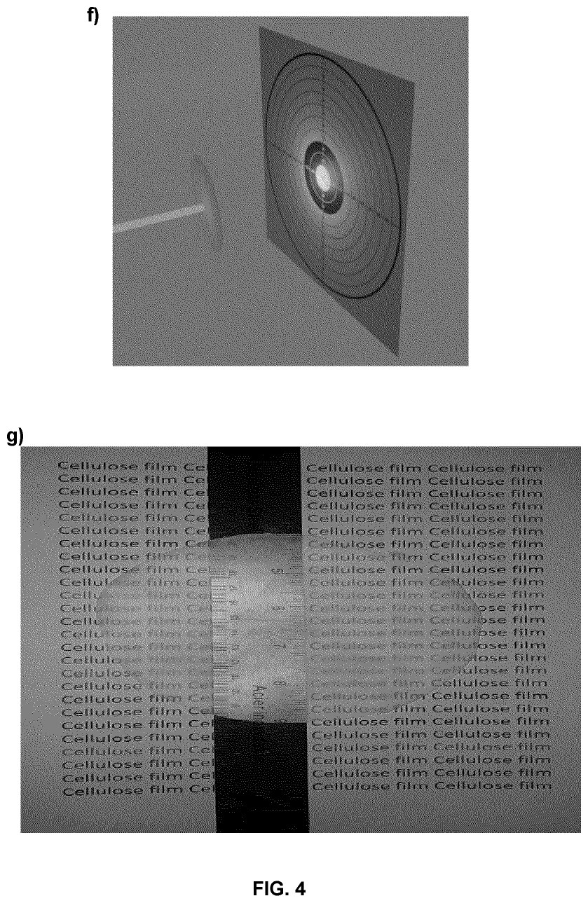

After disintegration treatment using cold alkaline solution and mechanical blending, the suspension can be facilely transformed into a thin film by vacuum filtration. Laser scattering was used to indicate the transparent and hazy performance of the film (FIG. 4a). When the laser beam passes through the film, the photons can be reflected, absorbed, transmitted, or scattered. The transmitted light is concentrated at the centre point of target, and the scattered light is shown as a gradient vague zone on the target (FIG. 4f). For the control film which is made from original pulp fibers, very low intensity of laser light can be observed due to the low photon transmittance. Significantly increased laser intensity can be observed for the film made from pulp fibers subjected to one (about 540 μm in length) and two (about 290 μm in length) treatment cycles, which suggests that more light can travel through due to the dense structure of the films that reduces light scattering resulting from the unmatched refractive index between air (1.0) and cellulose fibers (1.5). However, since the fibers are still relatively large in size after one and two treatment cycles, high scattering can still be observed as shown by the hazy appearance. The scattering effect is reduced by increasing the treatment cycles, which is expected due to the significantly reduced fiber diameters with increased treatment cycles. The representative film fabricated from pulp fibers subjected to four treatments was presented in FIG. 4b, and the optical transparency was visualized by a “see-through” experiment where the film was placed at different distances from the paper with color fonts underneath. The film showed very high transmittance when being placed in contact with the substrate, clearly revealing the details of the substrate. The letters got blurred when the film is moved away from the substrate and high opaqueness can be observed when the film is placed 21 mm from the substrate (FIG. 4b4). The transparency of the film prepared by different treatment cycles was quantified by UV-Vis spectrophotometer with and without integrated sphere (FIG. 4c and FIG. 4d). The results show that film transmittance increased by increasing treatment cycles, corresponding well to the reduced fiber dimensions after more treatment cycles. The inventors believe that the films consisting of smaller cellulose fibers tend to have more dense structure, which can more effectively reduce light scattering and further resulting in higher transmittance of the films. Specifically, for the “10%, −10° C., 4” film, the transmittance increased to 77% (without integrated sphere) and 89% (with integrated sphere) at 650 nm wavelength. This suggests a highly transparent and hazy film can be obtained by this simple cold alkaline and mechanical treatment. The as-prepared film showed similar transmittance as compared to the ones prepared by other more complicated chemical pretreatment methods, such as potassium permanganate oxidized and homogenized cellulose nanofibrils (80% T) and formic acid hydrolyzed and microfluidized cellulose nanofibrils (75% T). However, much fewer chemicals are used in this example as the pulp fiber does not need to go through extensive dissolution or nanofibrillation process, and the NaOH used for treatment can be largely recycled. The film is also flexible and foldable and can be folded into delicate creature such as paper crane without breaking, and the unfolded paper still shows intact structure without breakage (FIG. 4d). In addition, larger film (over 50 mm in diameter) can also be prepared by using bigger filtration setup, indicating its easy scalability (FIG. 4g).

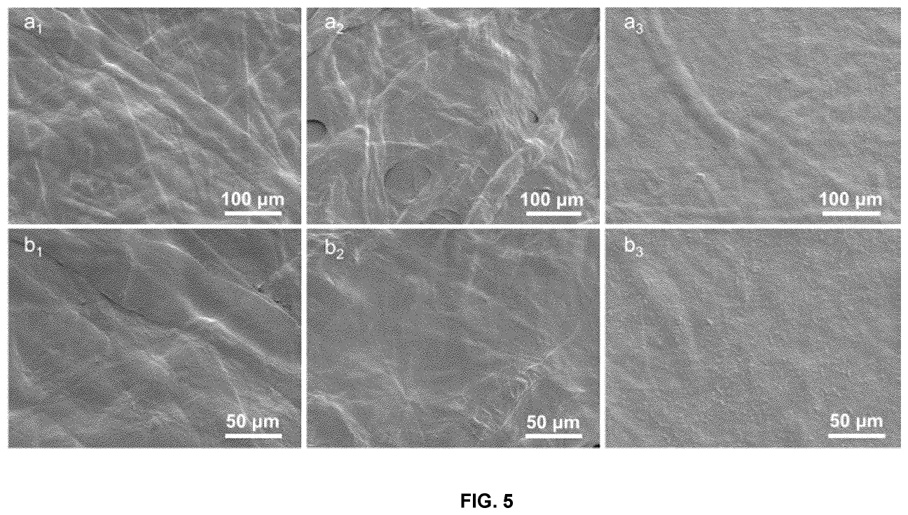

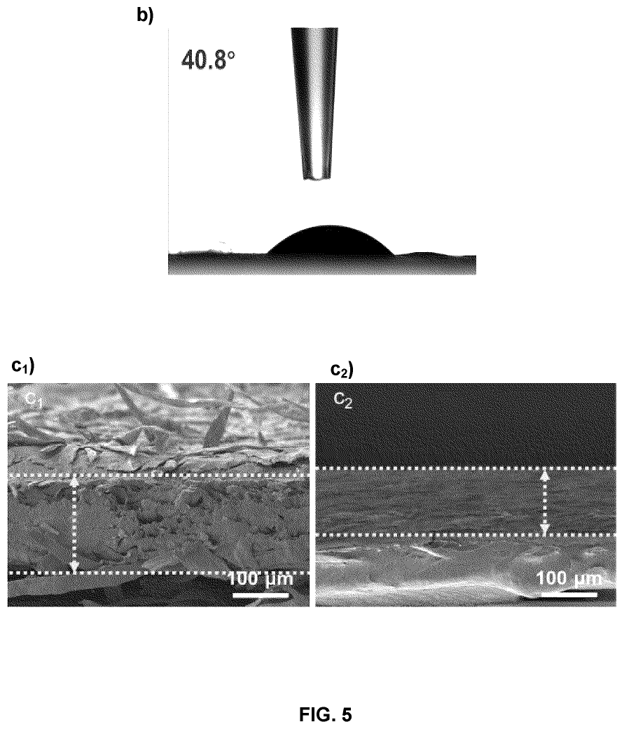

FIG. 5 are scanning electron microscopy (SEM) images. For films directly filtrated from the kraft pulp, long ribbon-like cellulose fibers can be clearly discerned from the surface, and these fibers interlaced with each other to form condensed network structure (FIGS. 5a₁ and 5b₁). These large fibers can clearly interfere the light pathway and therefore lead to low light transmittance. Large cellulose fibers can still be observed from the film prepared with one cycle NaOH/blending treatment, but with comparably lower fraction as compared to the original film (FIGS. 5a₂ and 5b₂). After four cycles of NaOH/blending treatment, the pulp can form more uniform and even film with much lower roughness (FIGS. 5a₃ and 5b₃). There are almost no large fibers being observed on the film, and all cellulose appears to merge with each other. Moreover, due to compact structure and low surface roughness as well as the hydrophilic nature of the treated cellulose fibers, this film exhibits a small water contact angle of 40.8° (FIG. 5b). In contrast, water contact angle is unable to be measured for the film made from untreated kraft pulp due to the porous structure. In addition to the top-view morphologies, cross-sectional morphologies of the films made from untreated kraft pulp and four cycles of NaOH/blending treatment were also studied. For the untreated cellulose film, the large cellulose fibers stacked on each other, creating a relatively rough and porous structure (FIG. 5c₁). By contrast, the film prepared with four cycles NaOH/blending treatment showed a highly ordered layered structure, which is quite dense and have almost no voids (FIG. 5c₂). Consequently, the highly smooth and dense structure of the treated film contributes to the high transmittance values as well as the improved mechanical properties that will be discussed later.

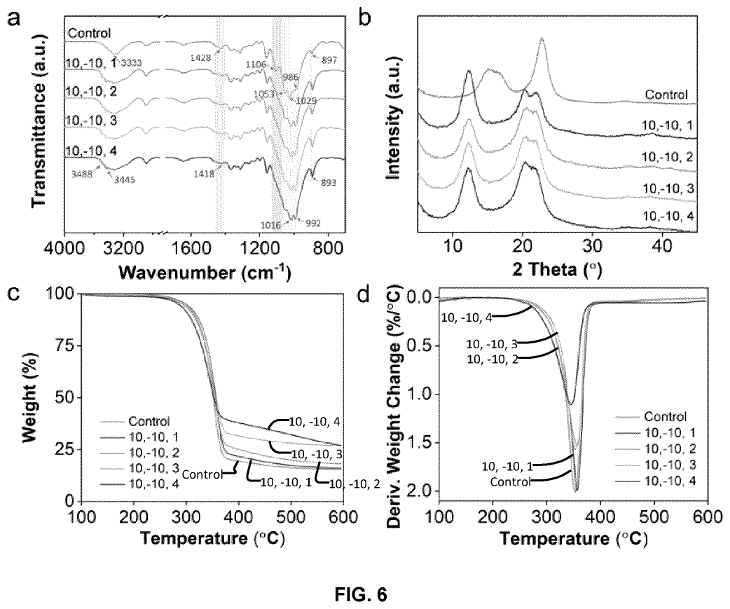

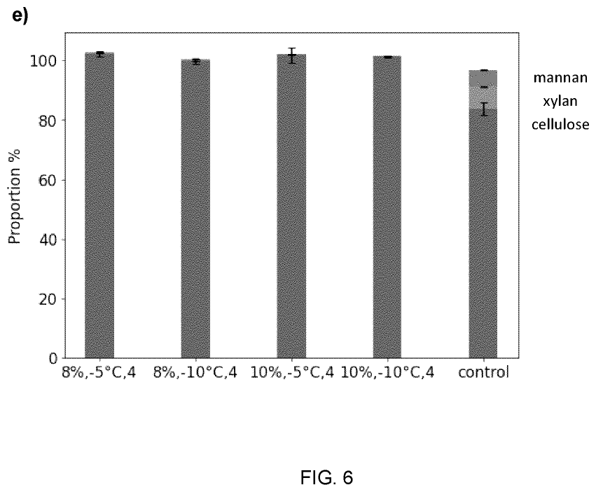

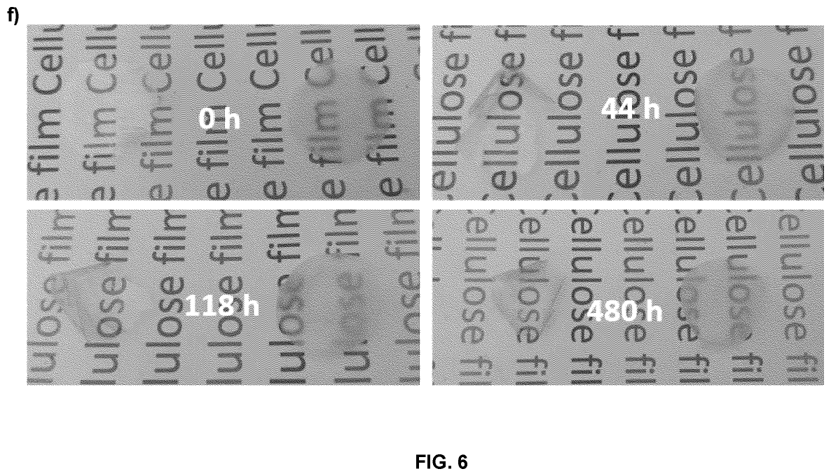

FTIR spectra of the films were performed to investigate the chemical structure change of the pulp fibers after different cycles of treatment (FIG. 6a). Significant differences can be observed among the spectra for original and treated pulp fibers. As shown in FIG. 6a, the original pulp showed the typical Cellulose I —OH stretching vibration peak at 3333 cm⁻¹. After NaOH treatment, two new peaks appeared at 3488 and 3445 cm−¹, indicating conversion to Cellulose II after NaOH treatment. Compared to the original pulp, the peak at 1428 cm⁻¹ assigned to —CH₂ symmetric bending or scissoring motions disappeared in the treated fibers, and a new peak at 1418 cm⁻¹ emerged, indicating the alteration of the conformation of CH₂OH at C6 from the “tg” to the “gt” form (rotation around the C3—O3 and C6—O6 bond). Furthermore, after NaOH treatment, the peak at 1106 cm⁻¹ flattened and the band at 1029 cm⁻¹ shifted to 1016 cm⁻¹, which is typical for the Cellulose II structure. Additional proof of transition from Cellulose I to Cellulose II can be observed from the shifting of the peak associated with β-glucosidic linkage from 897 cm⁻¹ to 893 cm−¹, due to the rotation of glucose residing around the glucosidic bond. All these transformations indicate that the cellulose crystalline structure transformed from Cellulose I to Cellulose II after cold NaOH treatment.

Fourier-transform infrared (FTIR) spectra was obtained to confirm the observed crystal allomorph change. The FIG. 6b X-ray diffraction (XRD) patterns indicated peak shift corresponding to the transformation from cellulose I to cellulose II during the cold NaOH treatment. In general, the original film exhibited three typical peaks at 20=14.7° (101), 16.5° (101) and 22.5° (021) for Cellulose I β. After one cycle of NaOH treatment at −10° C. and high speed blending, the peaks of Cellulose I disappeared, and additional peaks appeared at 2θ=12.5° (110), 20.2° (110), and 22.2° (020), which are characteristics of Cellulose II allomorph. The prominent change from Cellulose I to Cellulose II is consistent with the fiber swelling and disintegration observed from the optical microscopy images, which is caused by the synergistic effect of hemicellulose dissolution (FIG. 6e) and high-speed defibrillation. The crystallinity of the cellulose film was determined from Segal equation, showing values of 78.1%, 59.2%, 58.2%, 61.6% and 60.1% for the control sample, “10%, −10° C., 1”, “10%, −10° C., 2”, “10%, −10° C., 3” and “10%, −10° C., 4” films, respectively. The reduced crystallinity after NaOH swelling and disintegration is expected as some of the crystalline regions were swollen by the NaOH.

The FIG. 6e chemical composition of the control and chemically modified NBSK pulps were analyzed (in duplicate) according to the Klason protocol using TAPPI standard method T222. Briefly, 0.2 g of freeze-dried pulp substrate was Wiley milled and mixed with 3 mL of 72% H₂SO₄ for 2 hours. The mixture was diluted with 112 mL of deionized water and autoclaved at 121° C. for 1 hour. The carbohydrate components dissolved in the mixture were analyzed by a Dionex™ ICS-6000 High Pressure Ion Chromatography (HPIC), equipped with an anion exchange column (Dionex CarboPac™ PA1).

All films presented a similar thermal degradation pattern as compared to untreated pulp fibers. The degradation temperature of the films is ranging from 309° C. to 372° C., demonstrating excellent thermal stability (FIGS. 6c and 6d). For the fabricated films, the thermal stability showed a gradual decrease with increasing treatment cycles, with the temperature at the maximum degradation rate (Tₘₐₓ) for samples “10%, −10° C., 1” to “10%, −10° C., 4” decreasing from 356.4 to 355.7, 353.1, and 345.1° C., respectively. The lower degradation temperature that was observed in the samples which have undergone a greater number of treatment cycles can be attributed to the smaller fiber size, which results in higher surface areas being exposed to heat, thereby reduces the thermal stability. The degradation temperatures of these samples are much higher as compared to other transparent films from TEMPO oxidized cellulose nanofibrils. The lower degradation temperature of TEMPO-oxidized CNF film is due to the direct solid-to-gas phase transitions from decarboxylation of surface carboxyl groups. In addition, due to the oxidization and presence of oxidized groups (carbonyl and carboxyl groups), chromophores can form on the TEMPO-oxidized CNF and cause yellowing of the film when heated at 105° C. for 44 h. However, the current cellulose film does not show any color change even after heating for 480 h (FIG. 6f). Additionally, it was found that the treated films “10%, −10° C., 1” to “10%, −10° C., 4” showed char residues of 16.0, 18.1, 26.8 and 27.1%, respectively, which are much higher than that of untreated pulp (15.3%). The higher char residues found on the treated films may be the result of increased hydrogen bonding due to the smaller sized fibers and the transformation from Cellulose I to Cellulose II structures.

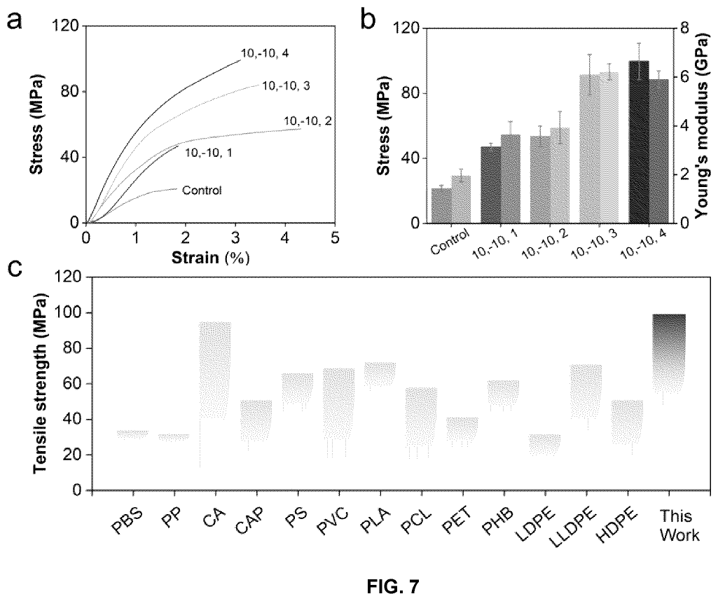

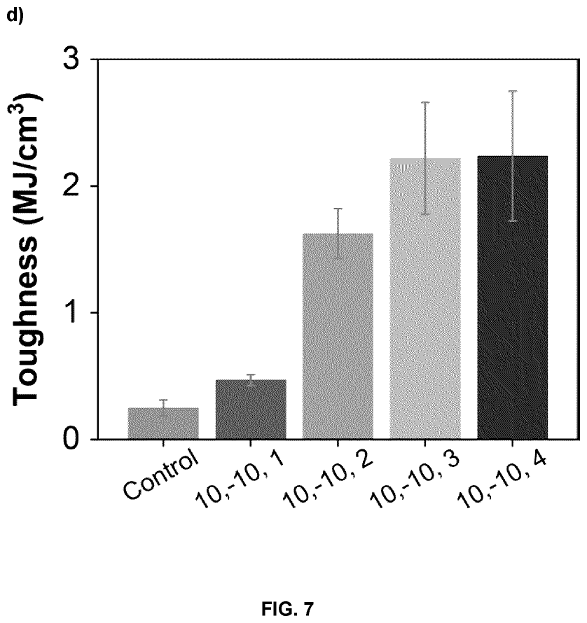

Tensile testing was performed to assess the mechanical property of the prepared film. The film made from original pulp fibers showed low stress and strain values (FIG. 7a), which is typical for paper-like film. The stress significantly increased after NaOH/blending treatment. Such trend continued with increasing treatment cycles. The Young's modulus also increased with increasing treatment cycles and levelled off after three cycles (FIG. 7b). The highest tensile stress was obtained for the “10%, −10° C., 4” film at 99.7 MPa with the highest Young's modulus of 5.9 GPa, which are around 4.6 and 3.0 times of the film from original pulp fiber, respectively. The “10%, −10° C., 4” film also demonstrated higher tensile stress and Young's modulus as compared to the carboxymethylated cellulose films made from dissolving pulp but comparable to those (with 1.5 and 2.5 mmol/g carboxyl charge densities) made from kraft pulp. The toughness values were also calculated from the tensile stress-strain curves, showing a similarly increasing trend with the treatment cycles (FIG. 7d). The “10%, −10° C., 4” film showed the highest toughness of 2.24 MJ/m³, which is almost 9 times greater than the control film (0.25 MJ/m³). The inventors believe that the high mechanical properties of the fabricated film may be attributed to the enhanced cellulose fusion by the NaOH and high-speed blending treatment as confirmed by the SEM images, which can lead to stronger interactions among cellulose fibers. Sufficient high-speed blending can promote micro/nano fibrillation of the pulp fibers to increase the specific surface area. During ultrafiltration, the swollen fibers may be compacted to fuse to each other, and hydrogen bonding may be regained upon NaOH removal during regeneration, further strengthening the network structure. In contrast, the control film showed relatively weaker mechanical properties, possibly due to the low interfacial interaction of its coarse fiber morphology. FIG. 7c is a plot of the tensile strength of the as-prepared film against other petrochemical-based and bio-based polymers (FIG. 7c, Table 1). The tensile strength of the current cellulose film is much higher than those of other common polymers, indicating its promising prospects to substitute partially or completely the plastic counterparts.

TABLE 1
List of tensile strength ranges of common plastics.

| | Min. strength | Max. strength |
|---|---|---|
| Plastic name | (MPa) | (MPa) |
| Polybutylene succinate (PBS) | 27 | 34 |
| Polypropylene (PP) | 26 | 32 |
| Cellulose acetate (CA) | 12 | 95 |
| Cellulose acetate butyrate (CAP) | 16 | 51 |
| Polystyrene (PS) | 40 | 66 |
| Poly(vinyl chloride) (PVC) | 7.1 | 68.9 |
| Poly(lactic acid) (PLA) | 52 | 72 |
| Poly(ε-caprolactone) (PCL) | 7.6 | 58 |
| Poly(ethylene terephthalate) (PET) | 21 | 41.4 |
| Poly(3-hydroxybutyrate) (PHB) | 40 | 62 |
| Low density polyethylene (LDPE) | 14.5 | 31.8 |
| Linear low density polyethylene | 25 | 71 |
| (LLDPE) | | |
| High density polyethylene (HDPE) | 13 | 51 |

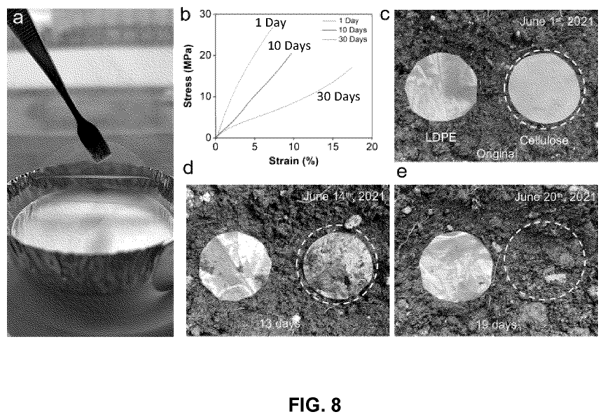

The inventors believe that due to the hydrophilic nature of pulp fiber and its capacity to form hydrogen bonds with water, cellulose film tends to disintegrate in water unless it is chemically crosslinked. The water stability of the as-prepared film was evaluated by immersing the film in water. The as-prepared film showed a well-maintained structure after 30 days of immersion (FIG. 8a). The results show that the tensile strength of the wet film can be maintained at 27.0 MPa after immersing in water for 1 day (FIG. 8b), and then decreased to 20.7 MPa after 10 days. Even after immersing in water for 30 days, the film can maintain a high tensile strength (17.2 MPa) with enhanced stretchability (from 7.4 to 17.5%). The enhanced stretchability of the film can be ascribed to the plasticizing effect of water that allows the fibers to slide against each other upon stretching. The inventors believe that the as-prepared film showed good wet strength possibly due to the fused swollen fibers during vacuum filtration and hot press, which may reduce the penetration of water molecules into the film, thereby retaining some intermolecular hydrogen bonding for providing good wet strength. The biodegradability of the film was conducted in natural environment by burying it into soil (in March 2021, Vancouver) at a depth of around 5 cm for 19 days, and the LDPE plastic was also buried at the same time for comparison. The film biodegradability was determined by visualizing their morphology change over time (FIGS. 8c-e). Some holes appeared in the film after 13 days due to degradation of the cellulose by microorganisms, and only a small piece of fractured film was left after 19 days of burial in the soil. From this, it may be predicted that the film will become completely biodegraded in subsequent days. In contrast, the LDPE film does not show any change after the same burial time (FIG. 8e, LDPE film after washing). The excellent performance for both wet stability, durability, and biodegradability of the film prepared by the example methods may be used to partially substitute current plastics and is of great significance to reduce environmental pollution and achieve carbon neutrality.

The results from the experiments performed in this example demonstrate that a strong, transparent, thermally stable, and biodegradable cellulose film can be facilely prepared from kraft pulp without going through the conventional chemical- and energy-intensive dissolution or nanofibrillation process. Kraft pulp can be swollen in 8-10% NaOH solution at sub-zero temperature (−5 to −10° C.), and such swollen fibers can be disintegrated using a household blender into highly stable cellulose microfibrils suspensions. The disintegrated cellulose suspension can be converted into transparent and hazy film by vacuum-aided ultrafiltration and hot-press, showing improved mechanical properties due to the fusion of cellulose fibers in the film. Although not chemically crosslinked, the cellulose film demonstrated excellent underwater stability that maintain the original shape and high tensile strength even after being immersed in water for 30 days. The cellulose film also showed good biodegradability that may be substantially completely degraded in 19 days after being buried in soil.

### Example 2

### Materials

Northern bleached softwood kraft (NBSK) pulp was provided by Pulp and Paper Centre at UBC (Vancouver, Canada). Sodium hydroxide (NaOH, 97%) was purchased from Thermo Scientific (Waltham, USA).

### Preparation of NaOH Swelling Cellulose Fiber Suspension.

In this experiment, NBSK pulp (3.0 g) was stirred in 10 wt % NaOH solution (297 g) for 10 min at −10° C. using an overhead stirrer. After that, the fiber suspension was transferred into a blender (VM0102B, Vitamix™, USA) and then blended at 27,000 rpm for 5 min. This completed one cooling-blending cycle, and the cycle was repeated 2 times. The obtained fiber suspension (1.0 wt %) was stored in refrigerator at 4° C. for future use.

### Preparation of Transparent Cellulose Film

6.28 g NaOH swelling cellulose fiber suspension was taken out and then diluted to 62.8 g with distilled water. The prepared 0.1 wt % cellulose fiber suspension was designated as CS-0.1. By controlling the amount of distilled water added, CS-0.3, CS-0.5, and CS-0.8 were also prepared. Subsequently, the suspensions were vacuum filtrated using a Nylon filter with a pore size of 0.8 μm, and the filtration times were recorded. The obtained wet films were then peeled off from the Nylon filter and soaked into distilled water to completely remove the residual NaOH. After that, the films were pressed to dry. The dried films were designated as CF-x, where x represents the concentrations of the cellulose fiber suspension.

### Characterization.

The morphologies of the cellulose fibers were observed using an optical microscope (OT 13181, Opti-Tech™, Canada). The morphologies of the prepared cellulose films were determined by a scanning electron microscope (Helios™ NanoLab 650, FEI, USA) in 5.0 kV. The optical properties of the prepared cellulose films were measured with a UV-Vis-NIR spectrophotometer (UV-3600, Shimadzu, Japan) equipped with an integrating sphere across the visible wavelength (400-800 nm). The tensile tests of the films were performed by a testing machine (5969, Instron™, USA). The contact angle of the films was measured with water droplets of approximately 3 μL in volume, using an optical tensiometer (TF300-PD200, Biolin, Sweden). The thermal stability of the films was performed using a thermogravimetric analyzer (Q500, TA, USA). The oxygen transmission rate of the films was measured using a gas permeability tester (C130, Labthink, China).

### Results

### 2.1 Rapid Fabrication of Highly Transparent Cellulose Film

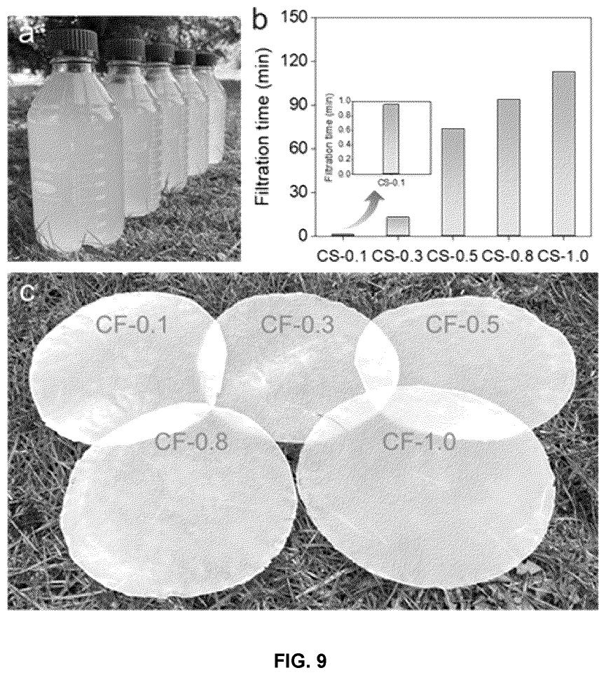

In this experiment, a rapid and scalable method of making transparent cellulose film was tested by using water as a drainage aid. The inventors believe that water can regulate the size of hydrated Na⁺ and OH⁻ ions by governing the NaOH concentration in the fiber suspension, which may assist to regulate the swelling of cellulose fiber and thereby assist to adjust the filtration time for cellulose film preparation. Kraft pulp was first treated by cold alkali swelling and high-speed blending to obtain CS-1.0. Due to the simple process, large scale fiber suspension (up to 5 L) can be readily manufactured (FIG. 9a). CS-0.1, CS-0.3, CS-0.5, and CS-0.8 were prepared by diluting CS-1.0, which were then used to make cellulose films with a grammage of 50 g/m² through vacuum filtration, and the filtration time was recorded, respectively. The results how that the filtration time was greatly reduced using cellulose suspensions with lower concentrations (FIG. 9b). For the film prepared from CS-0.1, the filtration time was less than 1 min. After drying, a set of highly transparent cellulose films (CF-0.1, CF-0.3, CF-0.5, CF-0.8, and CF-1.0) were obtained (FIG. 9c).

### 2.2. Morphology Characterization of Cellulose Fibers

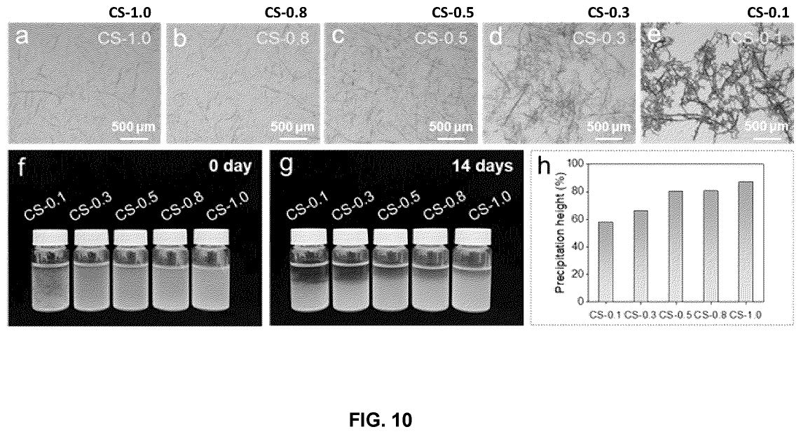

The morphologies of the cellulose fibers in the suspensions were characterized by optical microscopy. The fibers in CS-1.0 show apparent swelling, relatively transparent appearance, with fibers having a length of 500-1000 μm (FIG. 10a). Most individual fibers were observed to be separated from each other. After diluting with water to 0.8 wt % and 0.5 wt % concentrations, some fine fibers were found to aggregate together, forming small fiber clusters (FIGS. 10b and 10c). Compared to the single fibers, the fiber clusters show less exposed hydrophilic surface to water, thereby resulting in decreased water retention. The filtration speed for making films thus becomes faster. With the concentration of the fibers decreasing to 0.3 wt % and 0.1 wt %, results show that the swelling of the fibers decreases, as confirmed by the opaque fiber appearance and obvious boundaries between fibers and water (FIGS. 10d and 10e). The inventors believe that the less swollen big fibers bundle with the fine fiber clusters to form a fiber network. Such structure greatly weakens the interaction between the fibers and the water, and thus the filtration time of CF-0.1 was as short as 1 minute. The water-induced less swelling and aggregation behavior of the fibers may contribute to the greatly accelerated filtration. Without bound to any theory, the inventors believe that at sub-zero temperatures, the dissociated Na⁺ and OH⁻ in the fiber suspension interact with water molecules to form hydrated ions. Swelling of the fibers may be the result of the penetration of the hydrated ions into the amorphous and crystalline regions of the cellulose fiber and is closely related to the size of the hydrated ions. In this experiment, water was used to regulate the size of the hydrated ions. As the amount of water added increases, hydrated ions become too large to penetrate the fiber and separate cellulose chains effectively. Consequently, the isolated fine fibers bundle together again and the big fibers become less swollen with the help of hydrogen bonding. The morphology change of the fibers was confirmed by the precipitation tests (FIGS. 10f and 10g). A lower precipitation height was obtained with a decreased NaOH concentration (FIG. 10h). Since the precipitation height is inversely proportional to the density of the fibers, a lower precipitation height may indicate high density as a result of less water molecules diffusion into the less swollen fibers.

### 2.3. Characterization of Cellulose Films

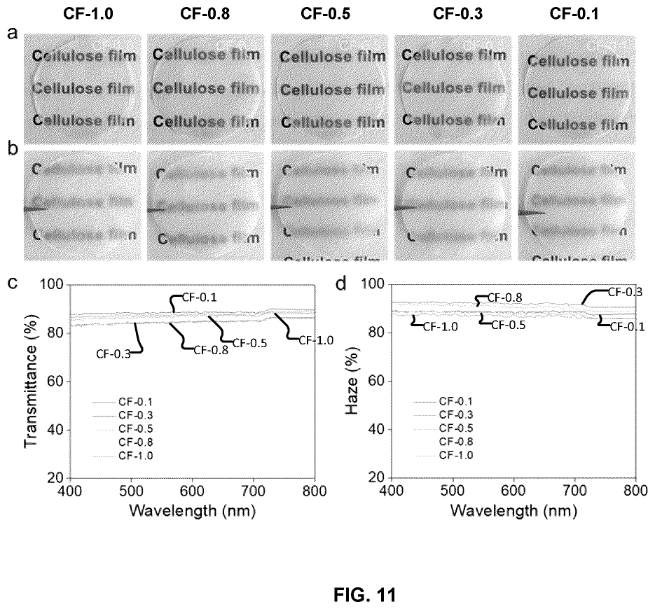

The optical property of the films was visualized by a “see-through” experiment. The “see-through experiment” involves placing the films in contact with color fonts. The films are considered to have high light transmittance if the colored letter underneath the films are clearly visible. FIG. 11a show that when the films were placed in contact with the color fonts, the colored letters underneath are clearly visible for all of the films, indicating their high light transmittance. When the films were placed around 3 mm away from the substrate (FIG. 11b), the letters become blurred, which may be attributed to the haze of the cellulose films. The light transmittance and haze of the films were quantified using a UV-vis spectrophotometer with an integrated sphere. The results show that all of the films show a similar transmittance over the whole measured range (FIG. 11c), despite the fiber size being visibly different from each other. The light transmittance was measured 88.7, 84.7, 87.0, 84.7, and 87.7% at 550 nm for CF-0.1, CF-0.3, CF-0.5, CF-0.8, and CF-1.0, respectively. The films also show similar haze in the range of 87-92% at 550 nm (FIG. 11d). This indicates that strong light scattering occurs in all of the films, but is less affected by the fiber size changes. The similar transparency and haze of the tested films support that production efficiency can be increased without sacrificing the optical properties of the films.

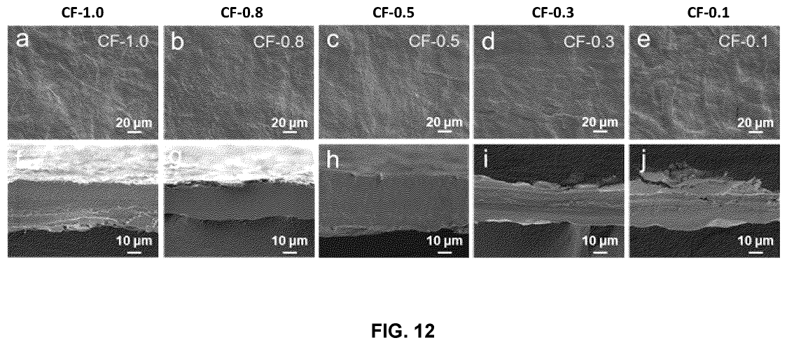

Scanning electron microscopy (SEM) imaging was performed to investigate the structure of the obtained films. For CF-1.0, it can be observed that long and flat fibers intertwine with each other, and they form a compact network structure (FIG. 12a). The inventors believe that such dense structure is favorable in facilitating light transmission, and thus the transmittance can reach up to 87.7% at 550 nm. Similar top-view morphology was observed in the CF-0.8 and CF-0.5 samples (FIG. 12b and FIG. 12c). In the CF-0.3 and CF-0.1 samples, the surface of the films becomes rough, and several fibers were observed to protrude (FIGS. 12d and 12e), which may cause increased forward light scattering and thus result in a high haze while still retaining high light transmission. In respect of the cross-sectional morphology of the films, all of the films show an ordered layered structure (FIGS. 12f-j), which facilitate light passing through the films, thereby contribute to high light transmission. A few internal cavities were observed, and these defects can cause light scattering, resulting in high haze of the films.

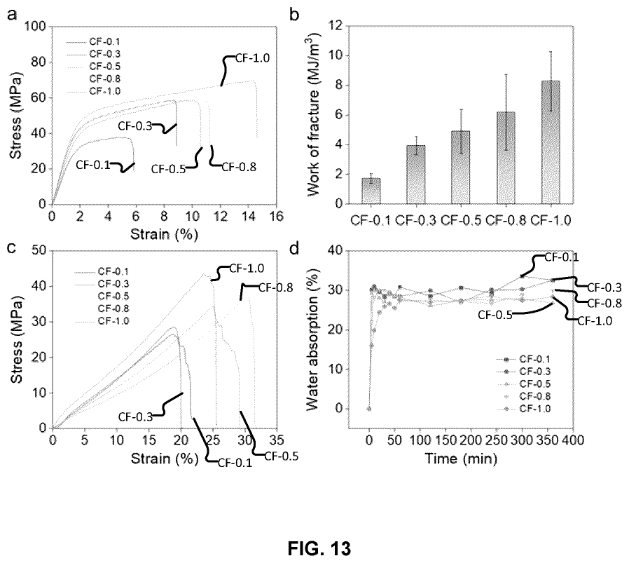

The results support that CF-1.0 exhibits the best mechanical performance with a stress of 69.8 MPa and a strain of 14.4% (FIG. 13a). The inventors believe that the high mechanical properties of the CF-1.0 sample may be attributed to the enhanced compact structure resulting from the NaOH and high-speed blending treatments. Specifically, cold NaOH treatment may make the cellulose fibers swell, which is conducive to the fibrillation of the fibers during high-speed blending. The swelling combined with the fibrillation of fibers lead to excellent mechanical performance of the CF-1.0 sample. For the CF-0.8, CF-0.5, and CF-0.3 samples, they show decreased mechanical strength of 61.5, 58.9, and 58.6 MPa, respectively, as compared to that of CF-1.0, but the decrease relative to CF-1.0 was calculated to be within 16%. The strain of the films dropped from 14.6% to 11.2%, 10.6%, and 8.8% due to the aggregation of the fine fibers. The stress and strain decrease to 37.3 MPa and 5.8% for CF-0.1, respectively. The change in stress and strain may be reflected by the work of fracture change of the films. CF-0.1 shows the lowest work of fracture with a value of 1.7 MJ/m³ among all the films (FIG. 13b). The work of fracture increased to 3.9-6.2 MJ/m³ for CF-0.3, CF-0.5, and CF-0.8, which is lower than that for CF-1.0 (8.3 MJ/m³). The wet strengths of the films were maintained at values between 26.4-43.6 MPa after immersing in water for 2 days (FIG. 13c). The high wet strength of the films may be attributed to their dense structure which can reduce penetration of water into the films, as demonstrated by the water absorption measurements (FIG. 13d). The inventors believe that some intermolecular hydrogen bonding may be retained for providing good wet strength of the films.

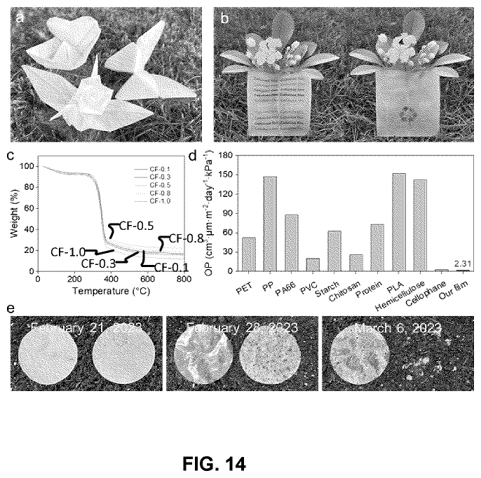

To demonstrate the potential applications of the films prepared the methods of this invention in packaging, the flexibility, printability, thermostability, barrier property, and biodegradability of the films were tested. The films can be easily folded into many handicrafts such as crane, rose, heart, boat, and butterfly (FIG. 14a), indicating good flexibility. The film also demonstrates good printability. Colorful patterns and text can be printed on the surface of the film (FIG. 14b). The thermostability of the films was studied by TGA. All films show similar thermal degradation curves, and the degradation temperature of the films ranges from 285 to 372° C. (FIG. 14c), which demonstrate excellent thermal stability. The films also exhibit an outstanding oxygen barrier property with a value of 2.31 cm³·μm·m⁻²·day⁻¹·kPa⁻¹ (FIG. 14d), outperforming most commonly used petroleum-based and bio-based polymers for packaging applications. The films degraded within 14 days when buried underground, while the polyethylene film cannot be degraded (FIG. 14e), indicating an excellent biodegradability.

The results of the experiments in this example support that a facile strategy was developed to rapidly prepare transparent and biodegradable cellulose films from wood pulp using water as a drainage aid. The inventors believe that water can regulate the swelling and aggregation behavior of the cellulose fibers to achieve high production efficiency. By adjusting the water added, a highly transparent (88.7%) cellulose film was prepared with a filtration time of one minute by separating means of vacuum filtration. The films demonstrated high mechanical strength (37.3-61.5 MPa), excellent oxygen barrier property (2.31 cm³·μm·m⁻²·day⁻¹·kPa⁻¹), good flexibility and printability as well as biodegradability.

### Example 3

### Materials

Northern bleached softwood kraft (NBSK) pulp was provided by Pulp and Paper Centre at UBC (Vancouver, Canada). Sodium hydroxide (NaOH, 97%) was purchased from Thermo Scientific (Waltham, USA).

### Preparation of Microfibril Cellulose (MFC) Slurry

NBSK was used as the starting material. NBSK suspension with a concentration of 5.0 wt % was fibrillated through a Super Masscolloider (MKCA6-5J, Masuko, Japan) at 1,500 rpm. The gap distance between the grinding stones was adjusted to −50 μm and passed 10 times. To prevent clogging of fibers in the grinder, the suspensions were sequentially passed grinder with gaps of +600 μm, +300 μm, +200 μm, +150 μm, +100 μm, +50 μm, +20 μm, +10 μm, 0 μm, and −20 μm for 8 times at each gap before passing the gap of −50 μm. The concentration of the final obtained MFC slurry is 2.23 wt %.

### Preparation of MFC Film

2.82 g MFC slurry was diluted to 12.56 g with distilled water to obtain a suspension. The suspension was vacuum filtrated using a Nylon filter with a pore size of 0.8 μm. The obtained wet film was subsequently peeled off from the Nylon filter and pressed to dry, and the dried MFC film was designated as MF.

### Preparation of High-Speed Blended MFC Film

67.3 g MFC slurry (2.23 wt %) was diluted to 200 g MFC suspension with a concentration of 0.75 wt %, and blended using a blender (VM0102B, Vitamix™, USA) at 27,000 rpm for 10 minutes. The blended MFC suspension was diluted to 0.5 wt %. 12.56 g of the diluted suspension was used to make the film through vacuum filtration. The obtained wet film can be dried by pressing. The dried film was designated as MF-B10.

### Preparation of NaOH Swelling MFC Film

The blended fiber suspension (200 g) was mixed with 10 wt % NaOH solution (100 g) and then stirred for 10 minutes at −10° C. using an overhead stirrer to prepare NaOH swelling MFC suspension (0.5 wt %). 12.56 g of the suspension was vacuum filtrated. The prepared wet film was peeled off from the filter and soaked into distilled water to completely remove the residual NaOH. The film was then pressed to dry, and the dried film was designated as MF-B10-C10.

### Characterization

The morphologies of the cellulose fibers were observed using an optical microscope (OT 13181, Opti-Tech, Canada). The morphologies of the prepared cellulose films were determined by a scanning electron microscope (Helios NanoLab 650, FEI, USA) in 5.0 kV. Fourier transform infrared spectra (FTIR, INVENIO, Bruker, Germany) of the films were measured in the 4000-700 cm⁻¹ range. The X-ray diffraction (XRD) patterns of the films were performed by an X-ray diffractometer (D8 ADVANCE, Bruker, Germany). The thermal stability of the films was performed using a thermogravimetric analyzer (Q500, TA, USA). The optical properties of the prepared cellulose films were measured with a UV-Vis-NIR spectrophotometer (UV-3600, Shimadzu, Japan) equipped with an integrating sphere across the visible wavelength (400-800 nm). The tensile tests of the films were performed by a testing machine (5969, Instron, USA).

### Results

### 3.1. Morphology and Dimension of Treated Cellulose Fibers and Fabrication of Highly Tough Cellulose Film

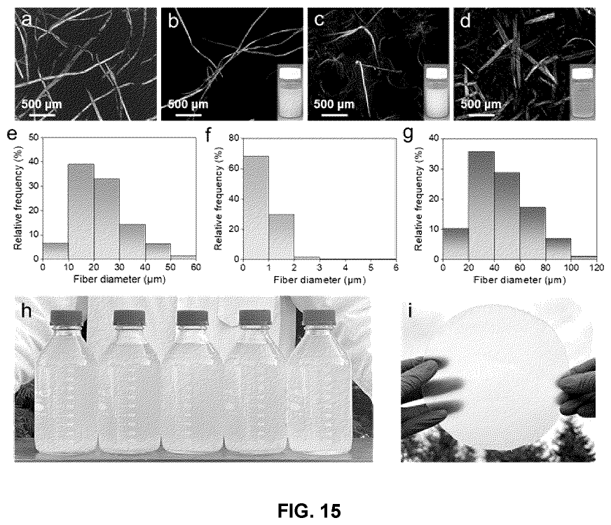

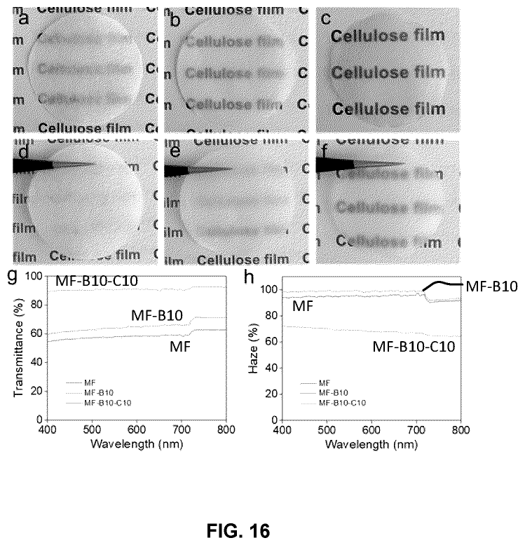

The morphology of the cellulose fibers before and after treatments was characterized by polarized optical microscopy. Original pulp fibers appeared long, with a high aspect ratio (FIG. 15a). After grinding, the diameter of the fibers show an apparent decrease (FIG. 15b), with an average value of 22.8 μm (FIG. 15e). Some small fiber branches were observed on the fibers surface. The inventors believe that the grinding treatment may assist to promote the liberation and fibrillation of the cellulose fibers. After being subjected to high-speed blending treatment, the fibers were fragmented into many short and thin fibers (FIG. 15c) under the strong mechanical blend force. The treated fibers showed decreased average diameter of 0.9 μm (FIG. 15f). Swelling which was induced by a ballooning effect was observed along the fibers after cold NaOH treatment (FIG. 15d). The average diameter of the fibers increased to 45.2 μm (FIG. 16g). The inventors believe that the big swelling can be attributed to the collective result of blending and cold NaOH treatments. Specifically, mechanical treatment can weaken and break the intermolecular hydrogen bonding, which may facilitate the penetration of hydrated ions into the amorphous and crystalline regions of the fibers. Due to the ease of blending and NaOH swelling treatments, large scale MFC suspension may be readily produced (FIG. 15h). A big cellulose film may be easily prepared through vacuum filtration (FIG. 15i).

### 3.2. Optical Properties of Cellulose Films

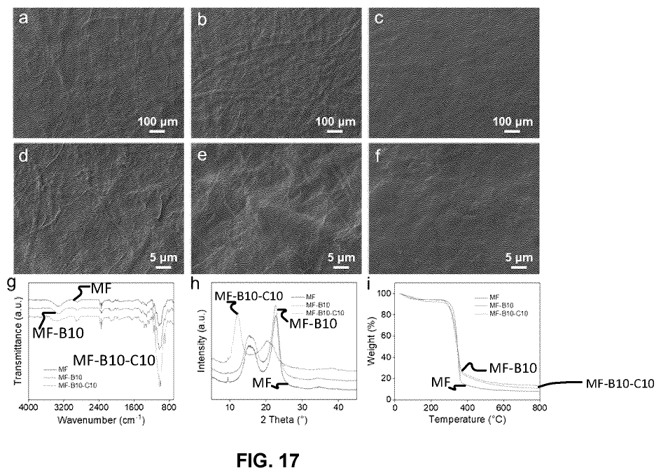

FIG. 17a to f are photographs demonstrating the light transmittance of the samples. For MF, the underneath colorful letters are vaguely visible when MF was placed closely to the substrate (FIG. 16a), indicating a low transmittance. For MF-B10, the clarity of the underneath letters increased from MF (FIG. 16b), suggesting a higher transmittance compared to MF. MF-B10-C10 was observed to have the highest transmittance among these three films, as demonstrated by the highly see-through underneath letters (FIG. 16c). When the films were placed around 3 mm away from the substrate, the underneath letters became blurry, which indicates the haze property of the films (FIGS. 16d-f). The blur gradually diminished for MF, MF-B10, and MF-B10-C10, indicating that the MF-B10-C10 sample showed to lowest haze value. The light transmittance and haze of the films were quantified using a UV-vis spectrophotometer with an integrated sphere. MF-B10-C10 showed the highest transmittance of up to 91.2% at 550 nm, while the transmittance of MF is only 58% (FIG. 16g). MF-B10-C10 showed the lowest haze at 69.3% at 550 nm (FIG. 16h), much lower than that of MF (95%) and MF-B10 (98.9%). These results indicate that less light scattering occurs in MF-B10-C10. The combination of blending and NaOH swelling treatments adventurously allows light passing through the film while reducing light scattering.

### 3.3. Morphology and Characterization of Cellulose Films

The morphology of the films was observed using scanning electron microscopy (SEM). For MF, long squashed cellulose fibers appeared on the surface, which interlaced with each other to form a dense network structure (FIG. 17a). At higher magnification, due to the fibrillation of grinding treatment, intertwined microfibers with lengths which are tens of microns were found on the film surface (FIG. 17d). Similar fiber network was observed in MF-B10 (FIGS. 17b and 17e), but the diameter of the fibers in MF-B10 was visibly smaller than the fibers in MF. The inventors believe that the smaller fiber size may have contributed to the denser and smoother structure of MF-B10, which may reduce light scattering, and thus MF-B10 presents a higher transmittance. MF-B10-C10 showed a more uniform top-view morphology with much lower roughness (FIGS. 17c and 17f). Almost no large fibers were observed on the film, and all of the fibers appeared to have merged together. The inventors believe that the dense and smooth structure of MF-B10-C10 allow most light to travel through the film, thereby resulting in high light transmittance.

FTIR spectra were obtained for each of the film samples to investigate the chemical structure change in the films after each treatment (FIG. 17g). The peak at 3328 cm⁻¹ represents the stretching vibration of the O—H band of cellulose I, which was observed in both MF and MF-B10, indicating the cellulose I structure of MF and MF-B10. For MF-B10-C10, two new peaks located at 3485 and 3440 cm⁻¹ appeared. The peak at 1106 cm⁻¹ became flat and the peak at 1029 cm−¹ shifted to 1016 cm−¹, indicating the conversion from cellulose I to cellulose II after cold NaOH treatment. The crystal allomorph change shown in FTIR was further confirmed by XRD analysis (FIG. 17h), as three peaks at 12.3°, 20.3°, and 22.2 representing typical cellulose II structure appeared. The thermal stability of the films was evaluated by TGA (FIG. 17i). All of the films showed a similar thermal degradation pattern. The degradation temperature of the films ranged from 274 to 370° C., demonstrating excellent thermal stability.

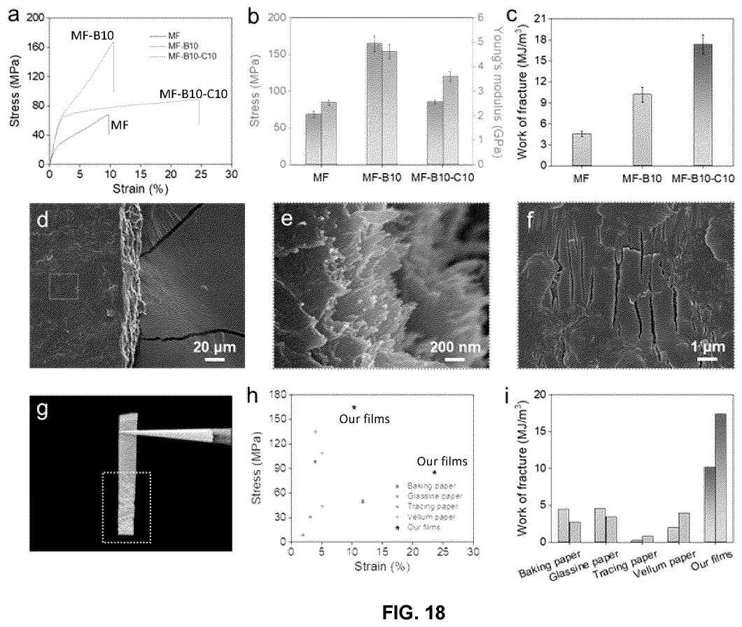

The mechanical properties of the films were evaluated by tensile testing. Significant differences were observed among the stress-strain curves for MF, MF-B10, and MF-B10-C10 (FIG. 18a). MF showed the lowest mechanical performance with a stress of 67.9 MPa and a strain of 9.8%. After blending treatment, the stress and strain of the film increased to 167.8 MPa and 10.6%, respectively, corresponding to the increase rates of 147.1% and 8.2%. Young's modulus also increased from 2.5 to 4.6 GPa (FIG. 18b). The inventors believe that the great enhanced stress and Young's modulus of MF-B10 may be attributed to the increased hydrogen bonding resulting from smaller fiber size, as compared to that of MF. More specifically, the smaller fibers of MF-B10 may not only provide increased specific surface area to promote stronger interaction between the fibers, but also contributes to the formation of a denser structure, which lead to a stronger network. Compared to MF, MF-B10-C10 presented 1.52 times enhanced strain, with a value of up to 24.7%, while the stress and Young's modulus of the film increased to 89.0 MPa and 3.6 GPa, respectively. This result may suggest that NaOH swelling may increase the stretchability of the film. The works of fracture of MF, MF-B10, and MF-B10-C10 were calculated to be 4.5, 10.1, and 17.3 MJ/m³, respectively (FIG. 18c). The morphology of the fractured MF-B10-C10 was investigated using SEM. A highly flat cross-section was observed (FIG. 18d), which may suggest that fibers were neatly pulled apart under tensile deformation. The fracture stress of MF-B10-C10 may have mainly come from the fracture of the cellulose fibers themselves rather than the breakage of the bonding between the fibers, as confirmed by the SEM image (FIG. 18e). MF-B10-C10 thus showed an increased stress. Some microcracks were found in the films (FIG. 18f), which may distribute the stress and increase the fracture tolerance of the film, and thus enabling high strain of MF-B10-C10. The length of these cracks ranged from several hundred nanometers to several micrometers, some of which were within the wavelength of visible light, resulting in a stress whitening of the fractured film (FIG. 18g). The tensile strength and strain as well as the work of fracture of our films (MF-B10 and MF-B10-C10) were plotted against other commercial transparent films/papers (FIGS. 18h and 18i). The film prepared by the methods of this invention outperform those samples.

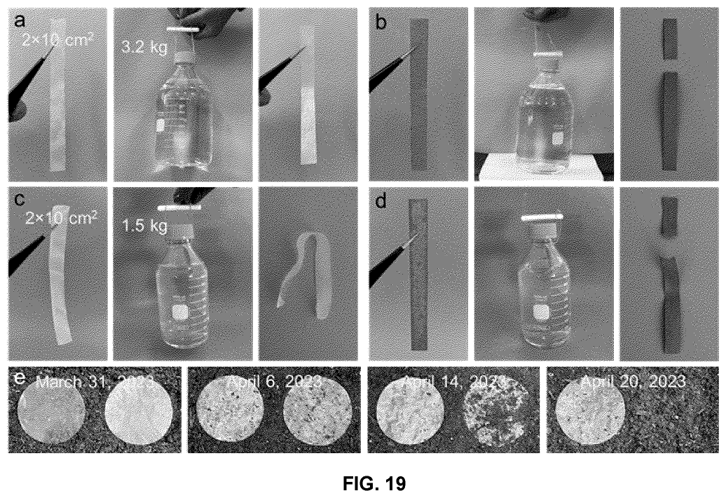

MF-B10-C10 was cut into a strip with a size of 10×2.0 cm², and its tensile strength was demonstrated. As shown in FIG. 19a, the strip was able to easily lift a 3.2 kg weight without damage. In contrast, a shopping bag from a local supermarket was also cut into the same size as the MF-B10-C10 strip, but it was not able to lift the weight and easily broke into two pieces (FIG. 19b). This suggests that the film prepared by methods of this invention exhibit better strength than the commercially available bag. To demonstrate the durability of the film in rainy weather, the MF-B10-C10 strip was soaked into water for 2 h, and then taken out to lift the weight. The wet MF-B10-C10 strip was able to lift a 1.5 kg weight and remain unbroken (FIG. 19c). The control sample was easily destroyed by the weight (FIG. 19d). The MF-B10-C10 film was completely degraded within 20 days when buried into soil, while the polyethylene film could not be degraded (FIG. 19e).

The results of the experiments performed in this experiment support that a strong, transparent, and biodegradable cellulose film with high toughness was developed through high-speed blending combined with cold NaOH treatments, followed by vacuum filtration. The high-speed blending decreases the fiber size and the cold NaOH treatment results in swelling of the fibers. The highly dense and smooth structure of the film allows it to exhibit high light transmittance (of up to 91.2% at 550 nm) and high tensile strength (of 89.0 MPa). The microcrack-induced stress whitening under tensile deformation improves the fracture tolerance of the film, with a high strain of 24.7%, and thus achieving 17.3 MJ/m³ work of fracture. The film prepared in this experiment also exhibits higher strength compared to the commercial shopping bag in both dry and wet states. The film created in this experiment shows good biodegradability and was completely degraded in 20 days after being buried in the soil. The high light transmittance, high mechanical strength and toughness, and good biodegradability make the film a promising candidate for packaging applications to partially substitute current plastics.

The following documents describe related technologies. Embodiments of the present technology may incorporate features as described in these references. All of the following references are hereby incorporated herein by reference as if fully set forth herein for all purposes.

### REFERENCES

1. Rochman, C. M.; Browne, M. A.; Halpern, B. S.; Hentschel, B. T.; Hoh, E.; Karapanagioti, H. K.; Rios-Mendoza, L. M.; Takada, H.; Teh, S.; Thompson, R. C., Classify plastic waste as hazardous. Nature 2013, 494, 169-171.
2. Geyer, R.; Jambeck, J. R.; Law, K. L., Production, use, and fate of all plastics ever made. Science Advances 2017, 3, e1700782.
3. Lambert, S.; Wagner, M., Environmental performance of bio-based and biodegradable plastics: the road ahead. Chemical Society Reviews 2017, 46, 6855-6871.
4. Li, T.; Chen, C. J.; Brozena, A. H.; Zhu, J. Y.; Xu, L. X.; Driemeier, C.; Dai, J. Q.; Rojas, O. J.; Isogai, A.; Wagberg, L.; Hu, L. B., Developing fibrillated cellulose as a sustainable technological material. Nature 2021, 590, 47-56.
5. Xia, Q. Q.; Chen, C. J.; Yao, Y. G.; Li, J. G.; He, S. M.; Zhou, Y. B.; Li, T.; Pan, X. J.; Yao, Y.; Hu, L. B., A strong, biodegradable and recyclable lignocellulosic bioplastic. Nature Sustainability 2021, 4, 627-635.
6. Wang, S.; Jiang, F.; Xu, X.; Kuang, Y. D.; Fu, K.; Hitz, E.; Hu, L. B., Super-strong, super-stiff macrofibers with aligned, long bacterial cellulose nanofibers. Advanced Materials 2017, 29, 1702498.
7. Jia, C.; Chen, C. J.; Kuang, Y. D.; Fu, K.; Wang, Y. L.; Yao, Y. G.; Kronthal, S.; Hitz, E.; Song, J. W.; Xu, F. J.; Liu, B. Y.; Hu, L. B., From wood to textiles: top-down assembly of aligned cellulose nanofibers. Advanced Materials 2018, 30, 1801347.
8. Aulin, C.; Gallstedt, M.; Lindstrom, T., Oxygen and oil barrier properties of microfibrillated cellulose films and coatings. Cellulose 2010, 17, 559-574.
9. Han, X. S.; Ye, Y. H.; Lam, F.; Pu, J. W.; Jiang, F., Hydrogen-bonding-induced assembly of aligned cellulose nanofibers into ultrastrong and tough bulk materials. Journal of Materials Chemistry A 2019, 7, 27023-27031.
10. Chen, Y. P.; Dang, B. K.; Jin, C. D.; Sun, Q. F., Processing lignocellulose-based composites into an ultrastrong structural material. ACS Nano 2019, 13, 371-376.
11. Qin, H. F.; Zhang, Y. F.; Jiang, J. G.; Wang, L. L.; Song, M. Y.; Bi, R.; Zhu, P. H.; Jiang, F., Multifunctional superelastic cellulose nanofibrils aerogel by dual ice-templating assembly. Advanced Functional Materials, 2021, 31, 2106269.
12. Ferreira, E. S.; Rezende, C. A.; Cranston, E. D., Fundamentals of cellulose lightweight materials: bio-based assemblies with tailored properties. Green Chemistry 2021, 23, 3542-3568.
13. Yang, Q. L.; Fukuzumi, H.; Saito, T.; Isogai, A.; Zhang, L. N., Transparent cellulose films with high gas barrier properties fabricated from aqueous alkali/urea solutions. Biomacromolecules 2011, 12, 2766-2771.
14. Yin, Y. N.; Zhang, C. G.; Yu, W. C.; Kang, G. H.; Yang, Q. L.; Shi, Z. Q.; Xiong, C. X., Transparent and flexible cellulose dielectric films with high breakdown strength and energy density. Energy Storage Materials 2020, 26, 105-111.
15. Zheng, X.; Huang, F.; Chen, L. H.; Huang, L. L.; Cao, S. L.; Ma, X. J., Preparation of transparent film via cellulose regeneration: Correlations between ionic liquid and film properties. Carbohydr. Polym. 2019, 203, 214-218.
16. Wan, J. Q.; Diao, H. L.; Yu, J.; Song, G. J.; Zhang, J., A biaxially stretched cellulose film prepared from ionic liquid solution. Carbohydr. Polym. 2021, 260, 117816.
17. Sun, X. X.; Wu, Q. L.; Ren, S. X.; Lei, T. Z., Comparison of highly transparent all-cellulose nanopaper prepared using sulfuric acid and TEMPO-mediated oxidation methods. Cellulose 2015, 22, 1123-1133.
18. Xu, X. Z.; Zhou, J.; Jiang, L.; Lubineau, G.; Ng, T.; Ooi, B. S.; Liao, H. Y.; Shen, C.; Chen, L.; Zhu, J. Y., Highly transparent, low-haze, hybrid cellulose nanopaper as electrodes for flexible electronics. Nanoscale 2016, 8, 12294-12306.
19. Zhu, H. L.; Fang, Z. Q.; Preston, C.; Li, Y. Y.; Hu, L. B., Transparent paper: fabrications, properties, and device applications. Energy & Environmental Science 2014, 7, 269-287.
20. Gao, S. S.; Wang, J. Q.; Jin, Z. W., Preparation of cellulose films from solution of bacterial cellulose in NMMO. Carbohydr. Polym. 2012, 87, 1020-1025.
21. Wang, Y.; Yuan, L.; Tian, H. F.; Zhang, L. N.; Lu, A., Strong, transparent cellulose film as gas barrier constructed via water evaporation induced dense packing. Journal of Membrane Science 2019, 585, 99-108.
22. Sun, X. X.; Wu, Q. L.; Zhang, X. Q.; Ren, S. X.; Lei, T. Z.; Li, W. C.; Xu, G. Y.; Zhang, Q. G., Nanocellulose films with combined cellulose nanofibers and nanocrystals: tailored thermal, optical and mechanical properties. Cellulose 2018, 25, 1103-1115.
23. Lassoued, M.; Crispino, F.; Loranger, E., Design and synthesis of transparent and flexible nanofibrillated cellulose films to replace petroleum-based polymers. Carbohydr. Polym. 2021, 254, 117411.
24. Kumar, V.; Bollstrom, R.; Yang, A.; Chen, Q. X.; Chen, G.; Salminen, P.; Bousfield, D.; Toivakka, M., Comparison of nano- and microfibrillated cellulose films. Cellulose 2014, 21, 3443-3456.
25. Osterberg, M.; Vartiainen, J.; Lucenius, J.; Hippi, U.; Seppala, J.; Serimaa, R.; Laine, J., A Fast method to produce strong NFC films as a platform for barrier and functional materials. ACS Applied Materials & Interfaces 2013, 5, 4640-4647.
26. Claro, F. C.; Matos, M.; Jordao, C.; Avelino, F.; Lomonaco, D.; Magalhaes, W. L. E., Enhanced microfibrillated cellulose-based film by controlling the hemicellulose content and MFC rheology. Carbohydr. Polym. 2019, 218, 307-314.
27. Budtova, T.; Navard, P., Cellulose in NaOH-water based solvents: a review. Cellulose 2016, 23, 5-55.
28. Kamide, K.; Okajima, K.; Kowsaka, K., Dissolution of natural cellulose into aqueous alkali solution—role of super-molecular structure of cellulose. Polymer Journal 1992, 24, 71-86.
29. Ladidi, K.; Korhonen, O.; Zrida, M.; Hamzaoui, A. H.; Budtova, T., All-cellulose composites from alfa and wood fibers. Industrial Crops and Products 2019, 127, 135-141.
30. Korhonen, O.; Sawada, D.; Budtova, T., All-cellulose composites via short-fiber dispersion approach using NaOH-water solvent. Cellulose 2019, 26, 4881-4893.
31. Korhonen, O.; Budtova, T., All-cellulose composite aerogels and cryogels. Composites Part A-Applied Science and Manufacturing 2020, 137, 106027.
32. Davidson, G. F., The dissolution of chemically modified cotton cellulose in alkaline solutions. Part I—In solutions of sodium hydroxide, particularly at temperature below the normal. Journal of the Textile Institute Transactions 1934, 25, T174-T196.
33. Isogai, A.; Atalla, R. H., Dissolution of cellulose in aqueous NaOH solutions. Cellulose 1998, 5, 309-319.
34. Nam, S.; French, A. D.; Condon, B. D.; Concha, M., Segal crystallinity index revisited by the simulation of X-ray diffraction patterns of cotton cellulose Is and cellulose 1l. Carbohydrate polymers 2016, 135, 1-9.
35. Koga, H.; Saito, T.; Kitaoka, T.; Nogi, M.; Suganuma, K.; Isogai, A., Transparent, conductive, and printable composites consisting of TEMPO-oxidized nanocellulose and carbon nanotube. Biomacromolecules 2013, 14, 1160-1165.
36. Jiang, F.; Kondo, T.; Hsieh, Y.-L., Rice Straw Cellulose nanofibrils via aqueous counter collision and differential centrifugation and their self-assembled structures. ACS Sustainable Chemistry & Engineering 2016, 4, 1697-1706.
37. Cuissinat, C.; Navard, P., Swelling and dissolution of cellulose Part II: Free floating cotton and wood fibers in NaOH-water-additives systems. Macromolecular Symposia 2006, 244, 19-30.
38. Uetani, K.; Yano, H., Nanofibrillation of wood pulp ssing a high-speed blender. Biomacromolecules 2011, 12, 348-353.
39. Fang, Z.; Zhu, H.; Bao, W.; Preston, C.; Liu, Z.; Dai, J.; Li, Y.; Hu, L., Highly transparent paper with tunable haze for green electronics. Energy & Environmental Science 2014, 7, 3313-3319.
40. Liu, Y. L.; Zhang, S. F.; Lin, R.; Li, L.; Li, M.; Du, M.; Tang, R. H., Potassium permanganate oxidation as a carboxylation and defibrillation method for extracting cellulose nanofibrils to fabricate films with high transmittance and haze. Green Chemistry 2021, 23, 8069-8078.
41. Du, H. S.; Parit, M.; Liu, K.; Zhang, M. M.; Jiang, Z. H.; Huang, T. S.; Zhang, X. Y.; Si, C. L., Engineering cellulose nanopaper with water resistant, antibacterial, and improved barrier properties by impregnation of chitosan and the followed halogenation. Carbohydr. Polym. 2021, 270, 118372.
42. Wang, H.; Chen, C.; Fang, L.; Li, S.; Chen, N.; Pang, J.; Li, D., Effect of delignification technique on the ease of fibrillation of cellulose II nanofibers from wood. Cellulose 2018, 25, 7003-7015.
43. Oh, S. Y.; Yoo, D. I.; Shin, Y.; Kim, H. C.; Kim, H. Y.; Chung, Y. S.; Park, W. H.; Youk, J. H., Crystalline structure analysis of cellulose treated with sodium hydroxide and carbon dioxide by means of X-ray diffraction and FTIR spectroscopy. Carbohydr. Res. 2005, 340, 2376-2391.
44. Li, R.; Wang, S.; Lu, A.; Zhang, L. N., Dissolution of cellulose from different sources in an NaOH/urea aqueous system at low temperature. Cellulose 2015, 22, 339-349.
45. Shabanpour, B.; Kazemi, M.; Ojagh, S. M.; Pourashouri, P., Bacterial cellulose nanofibers as reinforce in edible fish myofibrillar protein nanocomposite films. International Journal of Biological Macromolecules 2018, 117, 742-751.
46. Yue, Y. Y.; Han, G. P.; Wu, Q. L., Transitional properties of cotton fibers from cellulose i to cellulose ii structure. Bioresources 2013, 8, 6460-6471.
47. Jiang, F.; Hsieh, Y.-L., Chemically and mechanically isolated nanocellulose and their self-assembled structures. Carbohydr. Polym. 2013, 95, 32-40.
48. Jiang, F.; Hsieh, Y. L., Self-assembling of TEMPO oxidized cellulose nanofibrils as affected by protonation of surface carboxyls and drying methods. ACS Sustainable Chemistry & Engineering 2016, 4, 1041-1049.
49. Lee, K.; Jeon, Y.; Kim, D.; Kwon, G.; Kim, U. J.; Hong, C.; Choung, J. W.; You, J., Double-crosslinked cellulose nanofiber based bioplastic films for practical applications. Carbohydr. Polym. 2021, 260, 117817.
50. Parit, M.; Du, H.; Zhang, X.; Jiang, Z., Flexible, transparent, UV-protecting, water-resistant nanocomposite films based on polyvinyl alcohol and kraft lignin-grafted cellulose nanofibers. ACS Applied Polymer Materials 2022, 4, 3587-3597.
51. Liu, R.; He, X.; Miao, M.; Cao, S.; Feng, X., In-situ growth of porous Cu3(BTC)2 on cellulose nanofibrils for ultra-low dielectric films with high flexibility. Journal of Materials Science & Technology 2022, 112, 202-211.
52. Fukuzumi, H.; Saito, T.; Iwata, T.; Kumamoto, Y.; Isogai, A., Transparent and high gas barrier films of cellulose nanofibers prepared by TEMPO-mediated oxidation. Biomacromolecules 2009, 10, 162-165.
53. Fukuzumi, H.; Saito, T.; Okita, Y.; Isogai, A., Thermal stabilization of TEMPO-oxidized cellulose. Polymer degradation and stability 2010, 95, 1502-1508.
54. Ahn, K.; Zaccaron, S.; Zwirchmayr, N. S.; Hettegger, H.; Hofinger, A.; Bacher, M.; Henniges, U.; Hosoya, T.; Potthast, A.; Rosenau, T., Yellowing and brightness reversion of celluloses: CO or COOH, who is the culprit?Cellulose 2019, 26, 429-444.
55. Jiang, F.; Han, S.; Hsieh, Y.-L., Controlled defibrillation of rice straw cellulose and self-assembly of cellulose nanofibrils into highly crystalline fibrous materials. RSC Advances 2013, 3, 12366-12375.
56. Moradian, M.; Islam, M. S.; van de Ven, T. G., Insoluble regenerated cellulose films made from mildly carboxylated dissolving and Kraft pulps. Industrial & Engineering Chemistry Research 2021, 60, 5385-5393.
57. Wypych, G., Handbook of Polymers. 2nd Edition ed.; ChemTec Publishing: 2016.
58. Rafiqah, S. A.; Khalina, A.; Harmaen, A. S.; Tawakkal, I. A.; Zaman, K.; Asim, M.; Nurrazi, M. N.; Lee, C. H., A review on properties and application of bio-based poly(butylene succinate). Polymers 2021, 13, 1436.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
   in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for producing a polymeric material, comprising the steps of:
(a) blending a fibrous material to shear the fibers along a longitudinal direction of the fibers to obtain a blended fibrous material comprising blended fibers having an average diameter less than an average diameter of the fibers;
(b) mixing the fibrous material in a basic aqueous solution before step (a), or mixing the blended fibrous material in the basic aqueous solution after step (a);
(c) separating fibers contained in a mixture comprising the blended fibrous material and the basic aqueous solution; and
(d) drying the separated fibers.

2. The method according to claim 1, wherein the average diameter of the blended fibers is at least about 60%, or at least about 80% smaller than the average diameter of the fibers.

3. (canceled)

4. (canceled)

5. The method according to claim 1, wherein the mixing step (b) is performed at a temperature less than about 0° C.

6. The method according to claim 1, further comprising (e) pressing the separated fibers to produce a film.

7. The method according to claim 1, wherein the drying of the separated fibers in step (d) comprises pressing the separated fibers at a temperature between about 50° C. and about 105° C. to produce a film.

8. The method according to claim 1, wherein the blending speed used to blend the fibrous material in step (a) is greater than about 800 rpm, or between about 1.000 rpm and about 30,000 rpm.

9. (canceled)

10. (canceled)

11. The method according to claim 1, further comprising (f) mixing the fibrous material in a first solvent to form a slurry before the blending step (a), wherein the first solvent comprises water.

12. (canceled)

13. The method according to claim 11, further comprising (g) fibrillating the fibers contained in the slurry, wherein the fibrillatinq of the fibers contained in the slurry in step (g) comprises passing the slurry through a grinder.

14. (canceled)

15. (canceled)

16. (canceled)

17. The method according to claim 1, further comprising (h) diluting the blended fibrous material with a second solvent to a concentration before the separating step (c), wherein the second solvent comprises water.

18. (canceled)

19. (canceled)

20. (canceled)

21. (canceled)

22. (canceled)

23. (canceled)

24. The method according to claim 1, wherein the mixing step (b) is performed before the blending step (a).

25. The method according to claim 24, comprising repeating the mixing step (b) and the blending step (a) for a predetermined number of cycles before the separating step (c).

26. The method according to claim 25, wherein the predetermined number of cycles is between 1 and 10.

27. The method according to claim 1, wherein the blending step (a) is performed before the mixing step (b).

28. The method according to claim 1, wherein the fibrous material comprises pulp.

29. (canceled)

30. (canceled)

31. (canceled)

32. The method according to claim 1, wherein the basic aqueous solution comprises a metal hydroxide.

33. (canceled)

34. The method according to claim 1, wherein a concentration of the basic aqueous solution is in the range of from about 5 wt. % to about 20 wt. %.

35. The method according to claim 1, further comprising (i) removing residual basic aqueous solution from the separated fibers before the drying step (d).

36. (canceled)

37. (canceled)

38. The method according to claim 1, wherein the blending of the fibrous material in step (a) comprises shearing the fibers along a lateral direction of the fibers, wherein a mean length of the blended fibers is less than a mean length of the fibers, wherein the mean length of the blended fibers is at least about 50% less than the mean length of the fibers.

39.-122. (canceled)

123. A polymeric material produced by the method according to claim 1
wherein the polymeric material has a transmittance to visible light at a wavelength of 550 nm in the range of about 70% to about 95% when the film has a thickness between about 35 μm and about 50 μm, or
wherein the tensile strength of the polymeric material is in the range of from about 30 MPa to about 120 MPa when the film has a thickness between about 35 μm and about 50 μm, or
wherein the tensile strain of the polymeric material is in the range of from about 5% to about 30% when the film has a thickness between about 35 μm and about 50 μm.

124. (canceled)

125. (canceled)

126. (canceled)

127. The polymeric material according to claim 123, wherein the polymeric material comprises cellulose II.

128.-145. (canceled)
